(19) United States
(12) Patent Application Publication
(10) Pub. No.: US 2026/0123647 A1
(43) Pub. Date: May 7, 2026

(54) Food Compositions Having Allulose and Mastic Gum for Oral Care

(71) Applicant: Pulpdent Corporation, Watertown, MA (US)

(72) Inventors: RuiQi Song, Lexington, MA (US); Kenneth Berk, Newton, MA (US)

(21) Appl. No.: 19/438,029

(22) Filed: Dec. 31, 2025

Related U.S. Application Data
(63) Continuation-in-part of application No. PCT/US2024/012569, filed on Jan. 23, 2024.
(60) Provisional application No. 63/742,415, filed on Jan. 6, 2025.

(51) Int. Cl. A23G 1/48; A23G 1/32; A23G 1/40; A23G 1/44

(52) U.S. Cl. CPC A23G 1/48; A23G 1/325; A23G 1/40; A23G 1/44

(57) ABSTRACT

A food composition includes allulose having a concentration of about 43% to about 82% by weight, a cocoa product having a concentration of about 15% to about 50% by weight, and mastic gum or powder having a concentration of about 0.35% to about 2.71% by weight. A food composition also includes allulose having a concentration of about 55% to about 90% by weight, mastic gum or powder having a concentration of about 0.35% to about 5% by weight, and one or more plant-based proteins having a concentration of about 4.7% to about 32.5% by weight. The food compositions may further include secondary sweeteners, polysaccharide hydrocolloids, natural ingredients, plant-based nutrients, plant-based proteins, biominerals, vitamins and/or antioxidants as active ingredients. A confectionary product made with the food compositions and a method of making the food compositions are also disclosed. An allulose-based sweetener and method of making same are also disclosed.

### CROSS REFERENCE TO RELATED APPLICATIONS

The present application is a continuation-in-part of International Patent Application No. PCT/US2024/012569, filed Jan. 23, 2024, and claims the benefit of U.S. provisional patent application No. 63/742,415, filed Jan. 6, 2025, the disclosures of which are incorporated by reference herein in their entirety.

### TECHNICAL FIELD

The present invention relates to food compositions having allulose and mastic gum, and more specifically relates to low calorie and low glycemic food compositions having allulose and mastic gum that may be used for confectionary and snack products that promote oral health care, particularly with anti-plaque and anti-caries functions.

### BACKGROUND ART

Dental plaque is a naturally occurring, sticky biofilm composed primarily of bacteria that consistently develops on teeth and gums. Dental plaque starts to form again within minutes after a professional cleaning, typically returning to its previous state within 24-48 hours. Within this biofilm, various bacteria break down fermentable carbohydrates for growth, producing acids in the process. Frequent consumption of these carbohydrates can lead to excessive acid production, disrupting the bacterial balance in the biofilm, increasing the risk of enamel demineralization, and promoting cavities. See, e.g., Riva Touger-Decker et al. “Sugars and dental caries23,” The American Journal of Clinical Nutrition, Volume 78, Issue 4, 2003, Pages 881S-892S. Some bacteria also produce enzymes that convert fermentable carbohydrates to glucans, further enhancing biofilm development. If plaque is not removed, it eventually hardens into dental calculus (tartar), which is linked to gingivitis, periodontitis, teeth discoloration, and bad breath, and can only be removed by a dental professional.

The rapid formation of dental plaque biofilm, along with its sticky, acid-producing and reoccurring nature, makes regular and effective oral hygiene crucial for plaque control and reducing related oral disease. While traditional products like toothpastes, gels and mouth washes are designed to help loosen and remove plaque when used with brushing and rinsing, there is growing interest in anti-plaque food products such as chewy candies. These anti-plaque food products offer advantages over conventional options, which often require access to a sink or can be awkward to use, like dental floss. Functional foods are portable and convenient, fitting easily into a busy lifestyle and allowing for use multiple times a day, especially after meals. By turning oral care into a pleasant treat, anti-plaque food products encourage regular use and may help improve consumers' oral hygiene. Such anti-plaque food products could also make it simpler to care for the teeth of children and senior citizens, who may struggle with consistent brushing, effectively turning a snacking moment into a chance for oral care.

The fermentable sugars in traditional chewy candies and sticky snacks, like sucrose, glucose, and fructose, are metabolized by dental plaque bacteria into acids. These acids erode tooth enamel and contribute to plaque buildup. Over years, the confectionery industry has aimed to produce sugar-free or low-sugar alternatives that match the texture, mouthfeel, and shelf life of conventional chewy candies. Sweeteners such as maltitol, sorbitol, xylitol, and isomalt, common in sugar-free chews and gummies, avoid promoting tooth decay because bacteria cannot metabolize them. However, when eaten in typical candy portions, these poorly digested sugar alcohols often cause gastrointestinal issues like bloating and a laxative effect. These issues have created an ongoing demand for other bulk sweeteners suitable for chewy treats.

Allulose, a rare sugar that does not cause cavities, is well-tolerated, and has no effect on blood glucose, has become a promising option with potential anti-plaque benefits. See, e.g., Han S et al., “Unveiling the impact of allulose on oral microbiota and biofilm formation via a cariogenic potential assessment platform,” Front. Cell. Infect. Microbiol. 15:1670139 (2025). Allulose offers a wide range of systemic health advantages not found in many other sweeteners, such as anti-inflammatory, antioxidation, platelet aggregation-reducing, blood sugar-lowering, lipid-lowering, GLP-1-increasing, anti-obesity, and antiparasitic properties. See, e.g., FDA issues draft guidance regarding the declaration of allulose on the nutrition Facts label, (2019), https://www.fda.gov/food/cfsan-constituent-updates/fda-issues-draft-guidance-regarding-declaration-allulose-nutrition-facts-label; N. Mijailovic et al., “Rare Sugars: Recent Advances and Their Potential Role in Sustainable Crop Protection,” Molecules, 2021, 26(6), 1720; W. Zhang et al., “D-allulose, a versatile rare sugar: recent biotechnological advances and challenges,” Critical Reviews in Food Science and Nutrition, 2023, 63:22, 5661-5679; T. Shintani et al., “d-Allulose, a stereoisomer of d-fructose, extends Caenorhabditis elegans lifespan through a dietary restriction mechanism: A new candidate dietary restriction mimetic,” Biochemical and Biophysical Research Communications, 2017, 493(4), 1528-1533; F. Franchi et al., “Effects of D-allulose on glucose tolerance and insulin response to a standard oral sucrose load: Results of a prospective, randomized, crossover study,” BMJ Open Diabetes Research & Care, 2021, 9 (1), e001939; H. Y. Lee et al., “d-Allulose Ameliorates Hyperglycemia Through IRE1α Sulfonation-RIDD-Sirt1 Decay Axis in the Skeletal Muscle,” Antioxidants & Redox Signaling, 2022, 37(4-6), 229-245; F. Au-Yeung et al., “Comparison of postprandial glycemic and insulinemic response of allulose when consumed alone or when added to sucrose: A randomized controlled trial,” Journal of Functional Foods, 2023, 105, 105569. Choi S S et al., “Pathway Analysis of Allulose as a Sugar Substitute in Mitigating Thrombotic Risks in Sickle Cell Disease Patients,” Nutrients. 2024 Dec. 12; 16(24):4295; Cayabyab K B et al., “The Metabolic and Endocrine Effects of a 12-Week Allulose-Rich Diet,” Nutrients. 2024, 10, 16(12):1821.

Despite its potential, the use of allulose as a bulk sweetener in chewy confections is hindered by three main challenges. First, its high hygroscopicity and humectancy compared to sucrose lead to moisture absorption, causing softening, reduced chewiness, and cocoa fat blooming in chocolate products. See, e.g., W. Mu et al., “Recent Advances on Applications and Biotechnological Production of D-Psicose. Appl. Microbiol. Biotechnol. 2012, 94, 1461-1467; M. Ogawa, et al., “Effects of Rare Sugar D-Allulose on Heat-Induced Gelation of Surimi Prepared from Marine Fish,” J. Sci. Food Agric. 2017, 97, 5014-5020; Y. Xia et al., “Research Advances of d-allulose: An Overview of Physiological Functions, Enzymatic Biotransformation Technologies, and Production Processes,” Foods, 2021, 10(9), 2186; M. Bolger et al., “Effect of d-allulose, in comparison to sucrose and d-fructose, on the physical properties of cupcakes,” LWT, 2021, 150, 111989; O. Tas et al., “Investigation of the Hydration Behavior of Different Sugars by Time Domain-NMR,” Foods, 2022, 11(8), 1148. In low-water systems, allulose can also crystallize, creating a gritty texture which is undesirable for a chewy confection. The prior art suggests that maltodextrin with gelatin might mitigate this issue (see, e.g., U.S. Pat. No. 11,369,124). However, the high glycemic index and digestive effects of maltodextrin and the animal origin of gelatin present limitations.

Second, its high solubility causes allulose to dissolve too quickly in the mouth, shortening the lingering time needed for active ingredients to act and provide oral hygiene benefits. See, e.g., Xia et al., “Research Advances of d-allulose: An Overview of Physiological Functions, Enzymatic Biotransformation Technologies, and Production Processes,” Foods, 2021, 10(9), 2186. One skilled in the art understands that lingering time is (a) recording the time when the material is put in the mouth, (b) lightly chewing the material, and (c) recording the time when the material is no longer present in the mouth. The lingering time is determined by (c) minus (a).

Third, allulose is only 70% as sweet as sucrose and can impart a slow-onset with a little bitter aftertaste, especially at high concentrations. See, e.g., Belloir C et al., “A receptor-based assay to study the sweet and bitter tastes of sweeteners and binary sweet blends: the SWEET project,” Chem Senses. 2024, 49:bjae041; U.S. Pat. No. 10,869,494; U.S. Pat. Appl. Publ. No. 2021/0244057; and V. Tan et al., “Temporal sweetness and side tastes profiles of 16 sweeteners using temporal check-all-that-apply (TCATA),” Food Research International, 2019, 121, 39-47. Because allulose is less sweet and has a bitter aftertaste, allulose is typically blended with other sweeteners, such as sugar alcohols. For example, a combined use of allulose with erythritol and stevia was disclosed to improve the tasting profile of allulose. See, e.g., U.S. Pat. No. 10,869,494. However, erythritol raises health concerns, as emerging research links such ingredients to increased cardiovascular and stroke risks. See, e.g., Witkowski et al., “The artificial sweetener erythritol and cardiovascular event risk,” Nat. Med. 2023, 29(3):710-718; Berry et al., “The non-nutritive sweetener erythritol adversely affects brain microvascular endothelial cell function,” Journal of Applied Physiology 2025, 138:6, 1571-1577. Consequently, there is a need for allulose-based food compositions that maintain texture stability without maltodextrin, provide adequate lingering time without gelatin, and deliver a balanced sweetness without sugar alcohols, particularly for products designed to support oral hygiene.

### SUMMARY OF EMBODIMENTS

In one embodiment of the invention, a food composition includes allulose having a concentration of about 60% to about 70% by weight, a cocoa product having a concentration of about 20% to about 30% by weight, and at least one natural plant resin having a concentration of about 0.37% to about 2.19% by weight.

In related embodiments, the at least one natural plant resin may be mastic gum or powder. Other texturing materials, such as acacia gum or powder, guar gum or powder, locust bean gum or powder, and/or mushroom chitosan, may be further used. A ratio of the mastic gum to the allulose may range from about 1:9 to about 1:245, preferably about 1:15 to about 1:189, more preferably about 1:31 to about 1:188, and preferably the ratio of the mastic gum to the allulose may be about 1:95. A ratio of the mastic gum to the cocoa product may range from about 1:74 to about 1:12, preferably the ratio of the mastic gum to the cocoa product may be about 1:37. The cocoa product may include cocoa butter, cocoa paste and/or cocoa powder. The food compositions may further include one or more natural ingredients including polyphenol having a concentration of about 1.0% to about 2.0% by weight. The one or more natural ingredients may include grape seed extract, cranberry extract, elderberry extract, green tea extract, green tea powder, fennel seed extract, fennel seed powder, cardamom seed extract, cardamom seed powder, cinnamon extract, cinnamon powder, desugared beetroot powder, ginger extract, pumpkin seed powder and/or sesame seed powder. The food composition may further include one or more biominerals having a concentration of about 0.1% to about 0.2% by weight. A ratio of the one or more biominerals to the mastic gum may range from about 1:22 to about 1:2, preferably the ratio of the one or more biominerals to the mastic gum may be about 5:24. The one or more biominerals may include calcium and/or magnesium. The food composition may further include sunflower lecithin having a concentration of about 1% by weight.

In accordance with another embodiment of the invention, a confectionary product is made with any of the food compositions mentioned above.

In accordance with another embodiment of the invention, a method of making a healthy food composition includes melting a crystalline allulose to form a melted allulose, cooling the melted allulose to about 45° C. to about 70° C., adding at least one natural plant resin to the cooled melted allulose to form a mixture, and blending a melt of one or more cocoa products with the mixture to form any of the food compositions mentioned above.

In related embodiments, the method may further include adding one or more natural ingredients having polyphenol to the mixture. The method may further include adding one or more biominerals and/or sunflower lecithin to the melt of one or more cocoa products before blending with the mixture.

In another embodiment of the invention, a food composition includes allulose having a concentration of about 60% to about 90% by weight, preferably about 60% to about 70% by weight, a cocoa product having a concentration of about 8% to about 30% by weight, preferably about 8% to about 22% by weight, mastic gum or powder having a concentration of about 0.35% to about 2.19% by weight, at least one water-soluble plant protein having a concentration of about 0.1% to about 2% by weight, and water having a concentration of about 0.1% to about 10% by weight.

In related embodiments, the water-soluble protein may be brown rice protein. The formulation may further include at least one secondary sweetener having a concentration of about 1% to about 10% by weight, preferably about 3% to about 4% by weight, and preferably the secondary sweetener may be isomaltulose and/or trehalose. The ratio of the allulose to the secondary sweetener may be in the range of 10:1 to 30:1, preferably in the range of 20:1 to 25:1. The cocoa product may include cocoa butter, cocoa paste, and/or cocoa powder. The formulation may further include at least one polysaccharide hydrocolloid having a concentration of about 0.6% to about 6.0% by weight. The at least one polysaccharide hydrocolloid may include acacia gum or powder, guar gum or powder, locust bean gum or powder, gellan gum or powder, and/or xanthan gum or powder. The formulation may further include one or more natural ingredients that include polyphenols having a concentration of about 1.0% to about 2.0% by weight. The one or more natural ingredients may include grape seed extract, cranberry powder or extract, elderberry powder or extract, green tea powder or extract, coffee bean powder or extract, coffee cherry powder, hibiscus extract, calcium from algae, fennel seed powder or extract, cardamom seed powder or extract, cinnamon powder or extract, beetroot powder, acerola extract, papaya extract, and/or ginger extract. The formulation may further include one or more biominerals having a concentration of about 0.1% to about 0.2% by weight. The one or more biominerals may include calcium, magnesium, and/or phosphate. The formulation may further include a natural plant-based protein having a concentration of about 10% to about 15% by weight, preferably the natural plant-based protein includes almond protein powder, pumpkin seed protein powder, and/or sesame seed protein powder.

In another embodiment of the invention, a food composition includes allulose having a concentration of about 43% to about 82% by weight, a cocoa product having a concentration of about 15% to about 50% by weight, and mastic gum or powder having a concentration of about 0.35% to about 2.71% by weight.

In related embodiments, the food composition may further include one or more plant-based proteins having a concentration of about 0.05% to about 0.14% by weight. The food composition may further include at least one secondary sweetener having a concentration of about 0.6% to about 4% by weight, wherein the at least one secondary sweetener is isomaltulose and/or trehalose. The cocoa product may include cocoa butter, cocoa paste, and/or cocoa powder. The food composition may further include at least one polysaccharide hydrocolloid or gelling agent having a concentration of about 0.6% to about 1.9% by weight and water having a concentration of about 0.4% to about 1.0%, wherein the at least one polysaccharide hydrocolloid or gelling agent includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan. The food composition may further include one or more natural ingredients including polyphenol having a concentration of about 0.6% to about 2.5% by weight, wherein the one or more natural ingredients include grape seed extract, cranberry powder or extract, elderberry powder or extract, green tea powder or extract, coffee bean powder or extract, coffee cherry powder, hibiscus extract, fennel seed powder or extract, cardamom seed powder or extract, cinnamon powder or extract, beetroot powder, acerola extract, papaya extract, and/or ginger extract. The food composition may further include one or more biominerals having a concentration of about 0.1% to about 0.2% by weight, wherein the one or more biominerals includes calcium, magnesium, silicon, fluoride, and/or phosphate.

In another embodiment of the invention, a food composition includes allulose having a concentration of about 55% to about 90% by weight, mastic gum or powder having a concentration of about 0.35% to about 5% by weight, and one or more plant-based proteins having a concentration of about 4.7% to about 32.5% by weight.

In related embodiments, the one or more plant-based proteins may include almond protein, pumpkin seed protein, and/or sesame seed protein. The food composition may further include at least one secondary sweetener having a concentration of about 2% to about 4% by weight, wherein the at least one secondary sweetener is isomaltulose and/or trehalose. The food composition may further include a cocoa product having a concentration of about 0.1% to about 14.6% by weight, wherein the cocoa product includes cocoa butter, cocoa paste, and/or cocoa powder. The food composition may further include at least one polysaccharide hydrocolloid or gelling agent having a concentration of about 0.7% to about 2.0% by weight and water having a concentration of about 0.4% to about 1.4%, wherein the at least one polysaccharide hydrocolloid or gelling agent includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan. The food composition may further include one or more natural ingredients including polyphenol having a concentration of about 0.6% to about 2.5% by weight, wherein the one or more natural ingredients include grape seed extract, cranberry powder or extract, elderberry powder or extract, green tea powder or extract, coffee bean powder or extract, coffee cherry powder, hibiscus extract, fennel seed powder or extract, cardamom seed powder or extract, cinnamon powder or extract, beetroot powder, acerola extract, papaya extract, and/or ginger extract. The food composition may further include one or more biominerals having a concentration of about 0.1% to about 0.2% by weight, wherein the one or more biominerals includes calcium, magnesium, silicon, fluoride, and/or phosphate.

In accordance with another embodiment of the invention, a confectionary product is made with any of the food compositions mentioned above.

In accordance with another embodiment of the invention, a method of making a food composition includes melting a crystalline allulose to form a melted allulose, cooling the melted allulose to about 55° C. to about 65° C., adding mastic gum or powder to the cooled melted allulose to form a mixture, blending a melt of one or more cocoa products with the mixture to form a blended mixture, dissolving at least one water-soluble plant protein in water to form a gel solution, and adding the gel solution to the blended mixture to form any of the food compositions mentioned above.

In accordance with another embodiment of the invention, a method of making a food composition, such as the food compositions mentioned above, includes melting a crystalline allulose to form a melted allulose, cooling the melted allulose to about 45° C. to about 70° C., adding mastic gum or powder to the cooled melted allulose to form a mixture, and blending one or more plant-based proteins and/or one or more cocoa products with the mixture at a temperature of about 45° C. to about 70° C. to form a blended mixture.

In related embodiments, the method further includes melting at least one secondary sweetener with the crystalline allulose, wherein the mastic gum or powder is added to the cooled melted allulose and melted secondary sweetener to form the mixture, wherein the at least one secondary sweetener is isomaltulose and/or trehalose. The method further includes dissolving at least one polysaccharide hydrocolloid or gelling agent in water to form a gel solution and adding the gel solution to the blended mixture, wherein the at least one polysaccharide hydrocolloid or gelling agent includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan. The method further includes adding one or more natural ingredients comprising polyphenol to the blended mixture, wherein the one or more natural ingredients include grape seed extract, cranberry powder or extract, elderberry powder or extract, green tea powder or extract, coffee bean powder or extract, coffee cherry powder, hibiscus extract, fennel seed powder or extract, cardamom seed powder or extract, cinnamon powder or extract, beetroot powder, acerola extract, papaya extract, and/or ginger extract. The one or more plant-based proteins may include brown rice protein, almond protein, pumpkin seed protein, and/or sesame seed protein. The method further includes adding one or more biominerals having a concentration of about 0.1% to about 0.2% by weight, wherein the one or more biominerals includes calcium, magnesium, silicon, fluoride, and/or phosphate.

In accordance with another embodiment of the invention, a method of making an allulose-based sweetener for use in a food composition, such as the food compositions mentioned above, includes providing allulose having a concentration of about 75.0% to about 99.5% by weight of the allulose-based sweetener, melting the allulose to form a melted allulose, cooling the melted allulose to about 45° C. to about 70° C., and adding mastic gum or powder having a concentration of about 0.4% to about 4.0% by weight of the allulose-based sweetener to the cooled melted allulose to form a mixture. The method may further include melting at least one secondary sweetener with the allulose, wherein the mastic gum or powder is added to the cooled melted allulose and melted secondary sweetener to form the mixture, wherein the at least one secondary sweetener is isomaltulose and/or trehalose. The method may further include dissolving at least one gelling agent or polysaccharide hydrocolloid in water to form a gel solution and adding the gel solution to the mixture. When adding the at least one gelling agent or polysaccharide hydrocolloid to the mixture, the at least one gelling agent or polysaccharide hydrocolloid has a concentration of about 0.4% to about 7.0% by weight and water has a concentration of about 0.5% to about 9.0% by weight of the allulose-based sweetener. The at least one gelling agent or polysaccharide hydrocolloid may include acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan. The method may further include adding one or more plant-based high intensity sweeteners, such as monk fruit extract, having a concentration of less than 0.1% by weight of the allulose-based sweetener.

### BRIEF DESCRIPTION OF THE DRAWINGS

The foregoing features of the invention will be more readily understood by reference to the following detailed description, taken with reference to the accompanying drawings, in which:

FIGS. 1A-1B show processes of making an allulose-based sweetener used in food compositions according to embodiments of the present invention;

FIG. 2 is a graph of moisture absorption activity of an allulose-based sweetener versus mastic gum content for use in food compositions made according to embodiments of the present invention;

FIGS. 3A-3B are photographs of allulose-mastic gum sweetener components used in food compositions according to embodiments of the present invention;

FIGS. 4A-4B are photographs of allulose-mastic gum sweetener components having a water-based gel used in food compositions according to embodiments of the present invention;

FIGS. 5A-5C are photographs of a comparative Example using an allulose-based sweetener;

FIG. 6 is a graph of moisture uptake versus mastic gum content for food compositions made according to embodiments of the present invention;

FIGS. 7A-7E are photographs of food compositions made according to embodiments of the present invention after moisture uptake testing;

FIGS. 8A-8B are photographs of food compositions made according to embodiments of the present invention after storage at room temperature for over two months;

FIGS. 9A-9D are photographs of food compositions made according to embodiments of the present invention, which were wrapped and stored at room temperature for two months and then tested for firmness and photographed;

FIG. 10 is a graph showing the acidity produced by plaque samples after consuming Example A-1 made according to embodiments of the present invention;

FIG. 11 is a graph showing the acidity produced by plaque samples after consuming Comparative Example A; and

FIG. 12 is a graph showing the effects of three conditions in Example 13 on the taxonomic diversity of dental plaque samples (p) and saliva samples (S).

### DESCRIPTION OF ILLUSTRATIVE EMBODIMENTS

Embodiments of the present invention provide food compositions and methods of making same, which contain allulose as the main or only sweetener and have an improved storage stability with an acceptable chewy texture, lingering time length, taste, and flavor. Embodiments of the present invention also provide allulose-based sweeteners and methods of making same. Embodiments of the present invention also provide food compositions that combine allulose with natural ingredients to make food compositions having multiple functions in oral health. The food compositions may be used to make a confectionary product, such as chocolate candy. The food compositions may include chocolate confections, chewy confections, soft candy, hard candy, a combination of hard candy and chocolate, such as a snack bar or candy-sized snack with a soft and chewy filling and/or covered with a hard and chocolate coating, and/or chocolate covered nuts, berries, and vegetables as healthy snacks. The food compositions sweetened with allulose have a natural taste rich in chocolate and may be further modified with a blend of natural ingredients, which have properties as tasting modifiers, to create an acceptable overall sensory profile.

Embodiments of the present invention address the challenges mentioned in the prior art by providing a sweetener component having allulose and a natural plant-based resin, preferably mastic gum. Surprisingly, the addition of mastic gum to allulose significantly reduces the tendency of allulose to adsorb moisture. The incorporation of mastic gum transforms allulose into an allulose-mastic gum sweetener component that is well suited as a bulk sweetener for chewy foods, providing enhanced texture stability, an improved taste profile, and added functional benefits. Embodiments of the present invention provide the allulose-mastic gum sweetener component which exhibits greater resistance to moisture, preventing surface softening and stickiness in humid conditions. Embodiments with allulose and mastic gum also demonstrate non-crystallizing behavior after extended storage, as verified by accelerated testing, increase moisture resistance, and prevent clumping and stickiness in humid environments. The non-crystallizing behavior lasts over an expanded storage period, a property confirmed through accelerated crystallization testing. Mastic gum effectively masks the off-taste of allulose, contributing a freshening, aromatic note and having a more pleasant sweetness. As an elastomer with anti-microbial, anti-inflammatory and antioxidant properties, mastic gum imparts inherent multi-functionality, including intrinsic elasticity and antimicrobial activity to the allulose-based sweetener component.

Embodiments of the present invention provide a stable, portable, and functional food composition. Food compositions made with allulose-mastic gum sweetener component have a reduced moisture resistance, long lingering time with pleasant sensory characteristics, and a wide range of texture characteristics. Embodiments of the present invention provide a food composition that can help improve oral health and reduce the risks of dental issues. Embodiments of the present invention provide a food composition that suppresses metabolic activity of dental plaque bacteria, which is demonstrated by the reduced plaque bacterial regrowth and reduced acid production. Preferred embodiments may include an allulose-based sweetener functioning as a non-cariogenic sweetener that provides sweetness and bulk and mastic gum functioning as an intrinsic elastomeric agent, and optionally natural multi-minerals derived from Lithuthamnium coralloides, anti-adhesion agents, including allulose, mastic gum, cranberry extract, and/or grape seed extract, and antimicrobial and anti-inflammatory agents, including mastic gum, ginger root extract, fennel seed extract, cardamom seed extract, cinnamon bark powder, and/or green tea powder. The food compositions according to embodiments of the present invention allow its ingredients to work synergistically to help improve oral health via multimodal pathways by preventing bacteria adhesion, exerting antimicrobial effects, and providing mechanical disruption upon consumption. Furthermore, consumption of the food compositions supports a healthier oral microbiome by promoting microbial diversity, preserving beneficial genera, such as Veillonella. The reduction in acid production by bacteria like Streptococcus mutans helps prevent plaque formation, reduces gum inflammation, and neutralizes the oral environment. Additionally, the act of chewing stimulates saliva flow, which aids in clearing bacteria from the mouth and tongue, thereby improving breath quality.

The food compositions are low calorie and low glycemic compositions that include mastic gum (also known as Pistacia lentiscus) or mastic powder to impart an improved storage stability and chewy texture, an adjustable lingering time, and an acceptable taste and flavor. The combination of allulose and mastic gum with plant derived ingredients containing biominerals and polyphenols allows the food compositions to provide additional oral health care benefits. In addition, the mastic gum acts to help reduce or prevent crystallization when added into a melt with allulose and optionally a secondary sweetener, such as isomaltulose and/or trehalose. The film-forming property of mastic gum is believed to play an important role by absorbing and coating the surface of allulose molecules and forming an isolating layer around them, causing the recrystallization of allulose to be inhibited. Therefore, other conventional anti-crystallizing agents, such as corn syrup, hydrogenated starch hydrolysates syrup, soluble dietary fibers, and fondant, which have a high glycemic index, can be avoided with embodiments of the present invention. Further, the mastic gum and allulose combination, with an optional secondary sweetener, is compatible with a water-based gel having at least one water-soluble plant protein, and optionally at least one polysaccharide hydrocolloid of plant origin. When the mastic gum and allulose are combined with the water-based gel, the texture characteristics of the food compositions are improved to a surprisingly desirable extent, so that an allulose-based confectionery composition having a chewy and soft texture is obtained. Thus, embodiments of the present invention provide a unique composition that allows water, a water-soluble plant protein, and/or high intensity sweeteners, along with an optional polysaccharide hydrocolloid, to be used in the formulation. The use of high intensity sweeteners allows the incorporation of bulk nutrients with an increased concentration.

The food compositions according to embodiments of the present invention include allulose as the main or only bulk sweetener, a cocoa product, such as cocoa butter, cocoa paste and/or cocoa powder, and mastic gum or mastic powder as an active ingredient. Specifically, the food compositions include allulose having a concentration of about 60% to about 90% by weight, preferably about 60% to about 70% by weight, a cocoa product having a concentration of about 8% to about 30% by weight, preferably about 8% to about 22% by weight, and mastic gum or mastic powder having a concentration of about 0.35% to about 2.19% by weight of the overall composition. The food compositions may also include allulose having a concentration of about 43% to about 82% by weight, a cocoa product having a concentration of about 15% to about 50% by weight, and mastic gum or mastic powder having a concentration of about 0.35% to about 2.71% by weight of the overall composition.

Alternatively, or in addition, the food compositions according to embodiments of the present invention include allulose as the main or only bulk sweetener, mastic gum or mastic powder as an active ingredient, and one or more plant-based proteins. Specifically, the food compositions include allulose having a concentration of about 55% to about 90% by weight, mastic gum or mastic powder having a concentration of about 0.35% to about 5% by weight, and one or more plant-based proteins having a concentration of about 4.7% to about 32.5% by weight of the overall composition.

The mastic gum or powder is a hydrophobic, natural plant resin obtained from the mastic tree (Pistacia lentiscus). Mastic gum includes poly-beta-myrcene, triterpenic acids and esters, and small amounts of volatile terpenes, which provide anti-inflammatory, antibacterial, and antioxidant properties, and promote oral health. Other natural plant resins may be used instead of or in addition to the mastic gum, which include any resinous substance secreted from the bark of trees and the stems of other plants, which are low calorie, non-cariogenic, low glycemic, and have documented applications as food, beverage and medicinal additives, such as frankincense gum or powder, benzoin gum or powder, elemi gum or powder, sweetgum tree gum or powder, and Aleppo pine gum and powder.

The low calorie and low glycemic oral care food compositions provide a soft and chewy composition, similar to taffy but with little or no water. Replacing sugar with allulose in chewy confectionery presents a significant challenge to the chewy texture, mainly because allulose dissolves faster in saliva and lacks the resilient body of conventional candy. In embodiments of the present invention, the natural plant resin(s) functions as texturing agents, which alleviate the issues typically observed when using allulose. The texturing agents help compensate for the loss of texture and mouthfeel when sugar is fully replaced with allulose. The texturing agent is preferably dispersed well in allulose and melts without degradation. The natural plant resin(s) help to stabilize the overall texture of the food compositions, to improve sensory properties, to facilitate the oral care properties of the food compositions, and to act effectively in allowing the food compositions to resist structural changes, which may be caused by the hygroscopic property of allulose and lead to quality deterioration.

The allulose-based sweetener component includes allulose having a concentration of about 75.0% to about 99.5% by weight and at least one natural plant resin, preferably mastic gum or mastic powder, having a concentration of about 0.4% to about 4.0% by weight of the sweetener component. The mastic gum may have a ratio of mastic gum to allulose ranging from about 1:200 to about 1:15, preferably about 1:188 to about 1:31, and more preferably be about 1:95. The allulose-based sweetener component may further include a hydrogel having at least one gelling agent or polysaccharide hydrocolloid. When the at least one gelling agent or polysaccharide hydrocolloid is used, the gelling agent or polysaccharide hydrocolloid has a concentration of about 0.4% to about 7.0% by weight and water has a concentration of about 0.5% to about 9.0% by weight of the allulose-based sweetener. When cocoa is included in the food composition, a ratio of the mastic gum to the cocoa product or solids may range from about 1:145 to about 50:1, preferably about 1:74 to about 1:12, more preferably about 1:63 to about 1:10 or about 1:37. The presence of mastic gum significantly increases the lingering time of the food composition and enhances its firmness. Surprisingly, food compositions with a high content of allulose show a much lower tendency for texture softening on the surface when adding a particularly low amount of mastic gum. The storage stability of the food compositions is thereby considerably improved. An increased chewiness and prolonged lingering time are obtained by using mastic gum as the texturing agent or texture modifier. This is a new way of using mastic gum, different from the methods known in making conventional confections, which use gelatins to expand the shelf life of toffees and use water to dissolve the gelatin to allow the confection to have various functionalities, such as maintaining the texture and providing chewiness. The combination and use of allulose with mastic gum and other natural ingredients result in food compositions with an overall acceptable taste and flavor. In addition, the combination and use of allulose and mastic gum play an important role for incorporating and accommodating other natural ingredients, with different functions, and thus optimizing the potential of the food compositions for health care.

The food compositions according to embodiments of the present invention may further include one or more water-soluble plant-based proteins, such as brown rice protein, having a concentration of about 0.1% to about 2% by weight, and water having a concentration of about 0.1% to about 10% by weight of the overall composition.

The food compositions according to embodiments of the present invention may further include one or more plant-based proteins, such as almond protein, pumpkin seed protein, and/or sesame seed protein. When used with a significant amount of a cocoa product, such as a concentration of about 15% to about 50% by weight, the one or more plant-based proteins have a concentration of about 0.05% to about 0.14% by weight. When used with no cocoa product or a smaller amount of cocoa product, such as a concentration of about 0.1% to about 14.6% by weight, the one or more plant-based proteins have a concentration of about 4.7% to about 32.5% by weight of the overall composition.

The food compositions may further include a low glycemic and non-cariogenic secondary sweetener, preferably with a high melting point to achieve good heat stability. The one or more secondary sweeteners have a concentration of about 0.6% to about 10% by weight, preferably about 0.6% to about 4% by weight, and more preferably about 2% to about 4% by weight of the overall composition. For example, the secondary sweeteners may be isomaltulose and/or trehalose. Isomaltulose may be preferred over trehalose, because isomaltulose has a lower glycemic index. Isomaltulose, which is present in honey, is a disaccharide comprised of a glucose and fructose unit joined by an α-1,6-glycosidic bond. Because isomaltulose is digested much slower than sucrose and maltodextrin, isomaltulose has a lower glycemic response than sucrose and soluble dietary fibers, such as maltodextrin, making it acceptable to people with diabetes. Isomaltulose has been found not to be metabolized by oral pathogens to produce acids. In addition, isomaltulose can improve the sensory acceptability of foods. A ratio of allulose to isomaltulose ranging from about 10 to 30, preferably about 20 to 25, may be used, so that the softness and chewiness of the products is maintained and also the glycemic profile of the composition is minimized. When the composition contains more isomaltulose than allulose, the high glass transition temperature of isomaltulose leads to an increased firmness. The ratio of allulose and secondary sweeteners to mastic gum is preferably in the range of about 100-200.

The food compositions may further include one or more polysaccharide hydrocolloids or gelling agents having a concentration of about 0.6% to about 6.0% by weight, preferably about 0.6% to about 1.9% by weight or about 0.7% to about 2.0% by weight, and water having a concentration of about 0.4% to about 1.0% of the overall composition. The polysaccharide hydrocolloids or gelling agents may be incorporated in the form of a hydrogel prepared with water. The polysaccharide hydrocolloids or gelling agents may include acacia gum or powder, guar gum or powder, locust bean gum or powder, gellan gum or powder, xanthan gum or powder, cellulose gum, plant-derived chitosan, carob seed gum, tamarind seed gum, tara gum, gum tragacanth, agar, agarose, alginates, carrageenan, chia seeds, basil seeds, konjac, pectin, and/or pullulan. A ratio of acacia gum to mastic gum may range from about 4:5 to about 13:1, preferably about 6:1 to 1:6.

When water is incorporated into a component containing mastic gum, phase separation may occur due to the hydrophobic effect. Acacia gum is composed of hydrophilic polysaccharide chains and hydrophobic proteinaceous chains. When incorporated as a hydrogel, acacia gum forms a hydrocolloid network in the allulose-mastic gum matrix. Surprisingly, acacia gum works as an additive to stabilize and emulsify water and enables the incorporation of water into the allulose-based sweetener component without causing phase separation or crystallization of the allulose. Allulose-mastic gum-acacia gum sweetener components may be useful for making functional foods, providing easy access with a widely tunable texture characteristic. When the content of the hydrogel is low, the obtained sweetener component has a high viscosity and can be stretched with hands, indicating an intrinsic elasticity due to the incorporation of the mastic gum. When the content of the hydrogel is high, the obtained sweetener component has a lower viscosity that can be measured, but does not flow at room temperature. Compared to the allulose-mastic gum sweetener components that have a high viscosity and are suited for making anhydrous food compositions with long lingering characteristics, allulose-mastic gum-acacia gum sweetener components have a lower viscosity, may be used as a base material to carry a high content of bulking solids, and may be used for making paste and fillings for food compositions. The water compatibility of the allulose-mastic gum-acacia gum sweetener components allow the incorporation of many additional ingredients that are water soluble to improve the functions of the food compositions without compromising the texture stability. For example, ingredients may include high intensity sweeteners, such as monk fruit extract, flavoring agents, such as tea and coffee extracts, colorants, pH regulators, salts, minerals, antioxidants, amino acids and/or vitamins. The use of high intensity sweetener components allows the nutritional value of the food compositions to be improved without losing an equal sweetness by reducing the concentration of allulose and increasing the concentration of nutritive solids such as cocoa and plant-based protein ingredients.

The food compositions according to embodiments of the present invention may further include one or more natural ingredients, including botanical and herbal ingredients and extracts and other natural plant-based materials rich in vitamins, as a source of different types of phytochemicals, vitamins, and essential antioxidants comprising polyphenols, in particular a combination of A type and B types proanthocyanidins. For example, vitamin-rich ingredients such as acerola extract, which contains vitamins A and C, mushroom powder or mushroom extract, which contains vitamin D2, and/or papaya extract, which contains vitamins A, C, and E, and B complex vitamins, may be included as natural flavoring agents in the food compositions. Specifically, the one or more natural ingredients have a concentration of about 0.5% to about 2.5% by weight, preferably about 1.0% to about 2.0% by weight, of the overall composition. The one or more natural ingredients may include grape seed extract, cranberry powder or extract, elderberry powder or extract, green tea powder or extract, coffee bean powder or extract, coffee cherry powder, hibiscus extract, fennel seed powder or extract, cardamom seed powder or extract, cinnamon powder or extract, beetroot powder, acerola extract, papaya extract, and/or ginger extract. The food composition may further include sunflower lecithin having a concentration of about 1% by weight of the overall composition. The food composition may further include plant-based nutrients having a concentration of about 10% to about 15% by weight of the overall composition.

The food compositions according to embodiments of the present invention may further include one or more natural biominerals, which may include calcium, magnesium, silicon, fluoride, and/or phosphate. For example, the one or more biominerals may be calcium and magnesium carbonate from Lithuthamnium coralloides, which is also known as Boreolithothamnion corallioides, a calcified red algae that supplies a highly bioactive source of calcium, magnesium and other trace elements including phosphorus, fluoride, manganese, selenium and zinc that are essential for health. An exemplary composition of a Lithuthamnium coralloides extract is shown below in Table 1. Another example of a natural biomineral may be an extract derived from Lithothamnium calcareum, which is also known as Phymatolithon calcareum. Like Lithuthamnium coralloides, Lithothamnium calcareum crystallizes calcium and magnesium carbonate in cell walls during growth, and therefore, is rich in calcium, magnesium, and trace elements including phosphorus.

TABLE 1

| Element | Content (ppm) |
|---|---|
| aluminum | 79.5 |
| antimony | 2.99 |
| arsenic | 1.265 |
| barium | 7.22 |
| beryllium | 1.83 |
| bismuth | <0.5 |
| boron | 42.5 |
| calcium | 337000 |
| carbon | 125000 |
| cadmium | 0.659 |
| cerium | 0.7 |
| cesium | <0.001 |
| chloride | 38.9 |
| chromium | 3.39 |
| cobalt | 2.93 |
| copper | 3.65 |
| dysprosium | 0.116 |
| erbium | 0.083 |
| europium | 0.03 |
| fluoride | 0.18 |
| gadolinium | 0.115 |
| gallium | 0.162 |
| germanium | <0.001 |
| gold | 3.05 |
| hafnium | <0.001 |
| holmium | 0.026 |
| indium | 0.001 |
| iodine | 0.13 |
| iridium | 0.001 |
| iron | 1007 |
| lanthanum | <0.5 |
| lead | 0.038 |
| lithium | 6.28 |
| lutetium | 0.025 |
| magnesium | 30200 |
| manganese | 64.6 |
| mercury | <0.001 |
| molybdenum | 2.1 |
| neodymium | 0.387 |
| nickel | 3.28 |
| niobium | <0.5 |
| omsuim | 0.002 |
| palladium | 0.408 |
| phosphorus | 83.7 |
| platinum | 0.002 |
| potassium | 179 |
| praseodymium | 0.087 |
| rhenium | 0.002 |
| rhodium | 0.185 |
| rubidium | 0.01 |
| ruthenium | 2.284 |
| samarium | 0.09 |
| scandium | 0.928 |
| seleniun | <0.5 |
| silicon | 27.5 |
| silver | 3.01 |
| sodium | 4014 |
| strontium | 1947 |
| sulfur | 3916 |
| tantalum | <0.001 |
| tellurium | 5.47 |
| terbium | 0.02 |
| thallium | <0.5 |
| thorium | 2.23 |
| thulium | 0.011 |
| tin | 0.056 |
| titanium | 35.7 |
| tungsten | <0.5 |
| vanadium | 9.3 |
| ytterbium | 0.073 |
| yttrium | 4.82 |
| zinc | 3.56 |
| zirconium | <0.5 |

Specifically, the one or more natural biominerals have a concentration of about 0.1% to about 0.2% by weight of the overall composition. A ratio of the one or more biominerals to the mastic gum may range from about 1:22 to about 1:2, and preferably be about 5:24.

Embodiments of the present invention provide several benefits over the prior art allulose sweetened compositions, such as disclosed in KR 20170132151, U.S. Pat. Appl. Publ. Nos. 2018/0279643, US 2018/0271112 and U.S. Pat. No. 11,369,124. The food compositions according to embodiments of the present invention include mastic gum, which acts as a texturing, stabilizing, and emulsifying agent, and also adds nutritional benefits and health values. Food compositions made according to embodiments of the present invention combine allulose with natural ingredients having mastic gum, and may further include biominerals and high polyphenols ingredients, which function as pH neutralizing agents, antiplaque agents, anticaries agents, anti-gingivitis agents, saliva flow promoters, breath freshening agents, and agents for reducing dental hypersensitivity.

Food compositions made according to embodiments of the present invention provide oral health care benefits by fully replacing the sugar with allulose, which is noncarious. Chewy and soft confectionary products may be made from the food compositions which may last longer in the mouth. In addition, the confectionary products made from the food compositions according to embodiments of the present invention provide benefits over conventional confectionery compositions having cocoa solids with a chewy texture, such as chewy toffees, because the prior art confectionery compositions feed on carious inducing oral pathogens to promote plaque and produce acids for the demineralization of enamel and have limited shelf life due to the crystallization of the sugar.

Embodiments of the present invention provide food compositions that promote oral health without the adverse side effects experienced with existing oral hygiene products. Food compositions including allulose and mastic gum have the potential to overcome the limitations of conventional oral hygiene products by having extended retention in the oral cavity and releasing active agents in a sustained mode. The food compositions are portable and convenient, fitting a busy lifestyle and may be used several times a day, particularly after dining, to reinforce an anti-plaque cleansing effect. The food composition may be enjoyed by all age groups and available in a wide range of texture characteristics, such as textures that have an initial hardness similar to hard candy but then change to a chewy texture similar to taffy or have a chewy and soft texture that allows an immediate chew.

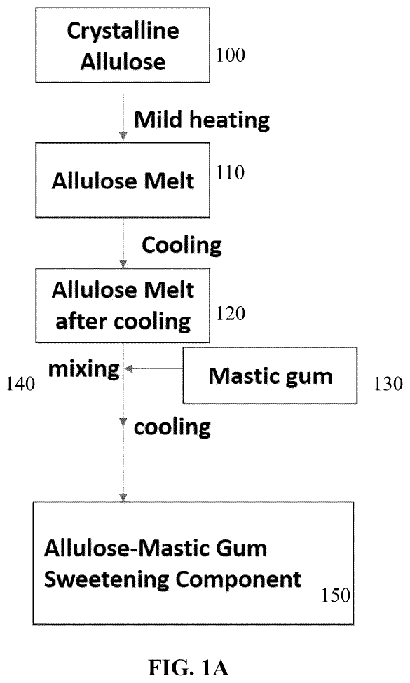

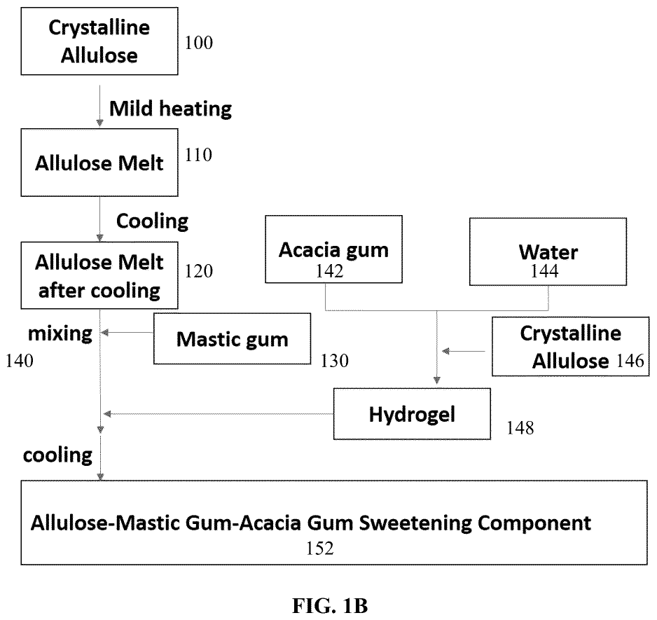

A process of making food compositions according to embodiments of the present invention begins by forming an allulose-based sweetener component, such as shown in FIGS. 1A and 1B. In FIG. 1A, the process begins at step 100 with melting crystalline allulose, preferably at a temperature range of about 90° C. to about 96° C., to form a melted allulose at step 110, and then cooling the mixture to about 45° C. to about 70° C. Once the melted allulose is cooled at step 120, the process further includes adding one or more natural plant gum resin materials, such as mastic gum and/or mastic powder, at step 130, to the cooled melted allulose to form a mixture at step 140. With vigorous mixing, the mastic gum integrates with allulose to form an allulose-mastic gum co-melt or mixture. The polymeric fraction of mastic gum, which is known for having a high mobility at or above room temperature due to its low glass transition temperature, disentangles and acts as a surface barrier around allulose molecules. The mixture forms the allulose-based sweetener component that may be further cooled and stored for later use at step 150 or used without further cooling/storing in the process of making the food composition. Upon cooling to room temperature, polymeric chains of mastic gum lose their mobility and get entangled to form a network. The network provides a physical barrier that helps allulose to resist moisture adsorption. As a result of incorporating mastic gum into the allulose, the allulose has significantly improved moisture resistance and the mastic gum helps delay nucleation, thus preventing the formation of an ordered allulose crystal lattice. As shown in the Examples below, the allulose-based sweetener component does not crystallize in an accelerated crystallization test. In addition, the as-prepared allulose-based sweetener component possesses an intrinsic elasticity and the aromatic flavoring note characteristic of mastic gum. When being heated to about 35-45° C., the components get softened and can be easily handled by pulling, pushing and folding to mix with other bulk ingredients for making food compositions according to embodiments of the present invention.

As shown in FIG. 1B, a process of forming an allulose-based sweetener component with a water-based gel begins with steps 100-140, as discussed above in FIG. 1A. In addition, the process includes forming the water-based gel by mixing water with crystalline allulose and optionally one or more secondary sweeteners, such as isomaltulose and/or trehalose, and/or gelling agents, such as one or more polysaccharide hydrocolloids, in steps 142, 144, 146 to form a hydrogel in step 148. The gelling agents may include acacia gum or powder, guar gum or powder, locust bean gum or powder, gellan gum or powder, xanthan gum or powder. cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan. The hydrogel is then added to the mixture (from step 140) to form the allulose-based sweetener with the water-based gel, which may be further cooled and stored for later use in step 152 or used without further cooling/storing in the process of making the food composition. A ratio of mastic gum to allulose in the sweetener component may range from about 1:15 to about 1:200, preferably about 1:153 to 1:200. A ratio of gelling agent, such as acacia gum, to mastic gum may range from about 4:5 to about 13:1, preferably about 6:1 to about 1:6.

If the allulose-based sweetener component (formed in step 150 or 152) is cooled or stored, the mixture may be re-heated to a temperature of about 45° C. to about 70° C. and then blended with one or more plant-based proteins and/or one or more cocoa products, preferably that are melted around 50° C., to form a food composition according to embodiments of the present invention. The plant resins have good compatibility with the melted allulose and the one or more plant-based proteins and/or one or more cocoa products. The one or more cocoa products can quickly soften and remain homogeneously dispersed in the mixture of melted allulose and the one or more natural plant gum resin materials when mixed together. Structural changes of the matrix of allulose that occur during further cooling allows the resin polymer network to form in-situ and be defined in the matrix, which helps maintain the stable texture of the food compositions by preventing the allulose in the matrix from re-crystallizing and resisting blooming.

Before or after blending the one or more plant-based proteins and/or the one or more cocoa products with the sweetener component mixture, biominerals and/or sunflower lecithin may be added to the mixture and mixed together. The plant-based protein and/or cocoa mixture containing biominerals and/or sunflower lecithin may be combined with the mixture of the allulose-based sweetener, and mixed together at a temperature range of about 45° C. to about 70° C. The as-obtained compound, which is sweetened and elastic, is removed from heat and cooled down to a temperature range of about 25° C. to about 30° C. The method may further include adding one or more natural ingredients having polyphenol to the mixture. The natural ingredients with polyphenols are blended in through kneading and stretching or pulling.

The process may further include dissolving at least one water-soluble plant protein, such as brown rice protein, in water at room temperature, e.g., by stirring, to form a gel solution. Optionally, allulose and one or more gelling agents or polysaccharide hydrocolloids may be dissolved in the water at room temperature with the water-soluble plant protein to form the gel solution. After the one or more cocoa products are melted, the process may further include adding the gel solution to the blended mixture to form the food composition according to embodiments of the present invention.

The method may further include adding natural ingredients, such as grape seed extract, cranberry powder or extract, elderberry powder or extract, green tea powder or extract, coffee bean powder or extract, coffee cherry powder, hibiscus extract, calcium from algae, fennel seed powder or extract, cardamom seed powder or extract, cinnamon powder or extract, beetroot powder, acerola extract, papaya extract, ginger extract, natural plant-based proteins, biominerals and/or sunflower lecithin to the blended mixture, before, during and/or after adding the gel solution. The cocoa mixture containing biominerals and/or sunflower lecithin may be combined with the mixture of allulose and the mastic gum or powder, and mixed together at a temperature range of about 45° C. to about 70° C. The as-obtained compound, which is sweetened and elastic, is removed from heat and cooled down to a temperature range of about 25° C. to about 30° C. The method may further include adding one or more natural ingredients having polyphenols to the mixture. The natural ingredients with polyphenols are blended in through kneading and stretching or pulling.

### EXAMPLES

### Sweetener Component Examples

### Examples S-I to S-IV: Allulose-Mastic Gum Sweetener Components

Experimental sweetener component samples S-I to S-IV shown in Table 2 were prepared by a method that includes: (a) melting crystalline allulose to form a melted allulose and avoid caramelization; (b) cooling the melted allulose to about 45° C.-70° C.; (c) adding mastic gum to the cooled melted allulose to form a homogeneous co-melt mixture; and (d) cooling the mixture obtained in step (c) to room temperature, as shown in FIG. 1A. Comparative Sample S was also prepared without mastic gum.

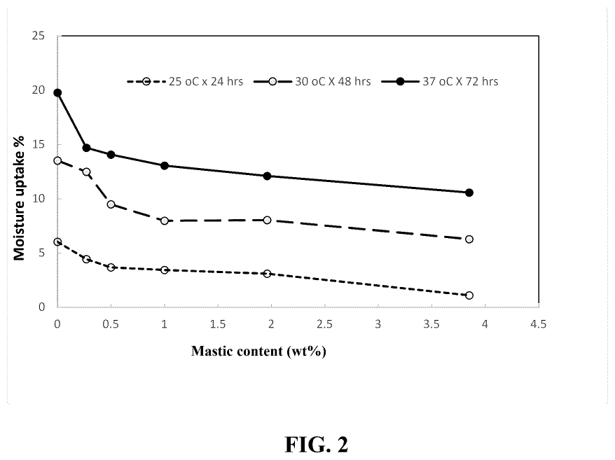

The moisture adsorption activity of six allulose-mastic gum sweetener components at various concentrations of mastic gum were investigated by measuring the difference in weight before and after the storage experiment. Plastic containers and vials were incubator dried at 40° C. for at least 1 hour and cooled down in a closed contained for at least 3 hours before the storage experiment. Samples of 5.0±0.1 g were weighed and filled in the vial (60 mL). Each sweetener component was tested with three samples. Each sample was placed in a closed container (32 oz). Before closing the containers, another uncapped vial with a 20.0000 f 0.0005 g of deionized water and a portable hygrometer and thermometer were put into each cup. The cups were put into an incubator with temperature set at 25.0±0.2° C. or 30.0±0.2° C. Filling the vial with 20.0000 g of distilled water kept the relative moisture in each closed cup at 85±2% at 25° C. After the 24-hour storage experiment for 25.0±0.2° C., 48-hour storage experiment for 30.0±0.2° C., and 72-hour storage experiment for 37.0±0.2° C., the vials with samples were weighed. The moisture adsorption is expressed as a percentage of weight gain. FIG. 2 is a graph of the moisture adsorption activity of the allulose-mastic gum sweetener components versus the mastic gum concentration. After 24 hours at 25.0±0.2° C., there was a noticeable distinction among six samples. Compared to Comparative Sample S, which did not contain mastic gum, the allulose-mastic gum sweetener components showed a remarkable reduction in moisture adsorption, which increased with an increasing content of mastic gum. After 48 hours at 30.0±0.2° C., the effect of mastic gum on improving moisture resistance was even more remarkable.

The crystallization stability of the samples was evaluated by accelerating crystallization at 4° C. and visually monitoring at different intervals. The result is shown in Table 2, where a change larger than 0 indicates that crystallization was observed, and a larger number indicating a higher level of crystallization.

TABLE 2
Crystallization level of swertening components
at different time points when stored at 4° C.

| Allulose-based | | | | | | | |
|---|---|---|---|---|---|---|---|
| sweetening | | | 3 | 1 | 2 | 4 | 8 |
| components | Ingredient | Content | days | week | weeks | weeks | weeks |
| Comparative | Allalose | 100% | 0 | 0 | 0 | 0 | 0 |
| sweetening | | | | | | | |
| sample S | | | | | | | |
| Experimental | Allalose | 99.50% | 0 | 0 | 0 | 0 | 0 |
| sweetening | Mastic | 0.50% | | | | | |
| sample S-I | gum | | | | | | |
| Experimental | Allalose | 99.00% | 0 | 0 | 0 | 0 | 0 |
| sweetening | Mastic | 1.00% | | | | | |
| sample S-II | gum | | | | | | |
| Experimental | Allalose | 98.04% | 0 | 0 | 0 | 0 | 0 |
| sweetening | Mastic | 1.96% | | | | | |
| sample S-III | gum | | | | | | |
| Experimental | Allalose | 96.15% | 0 | 0 | 0 | 0 | 0 |
| sweetening | Mastic | 3.85% | | | | | |
| sample S-IV | gum | | | | | | |

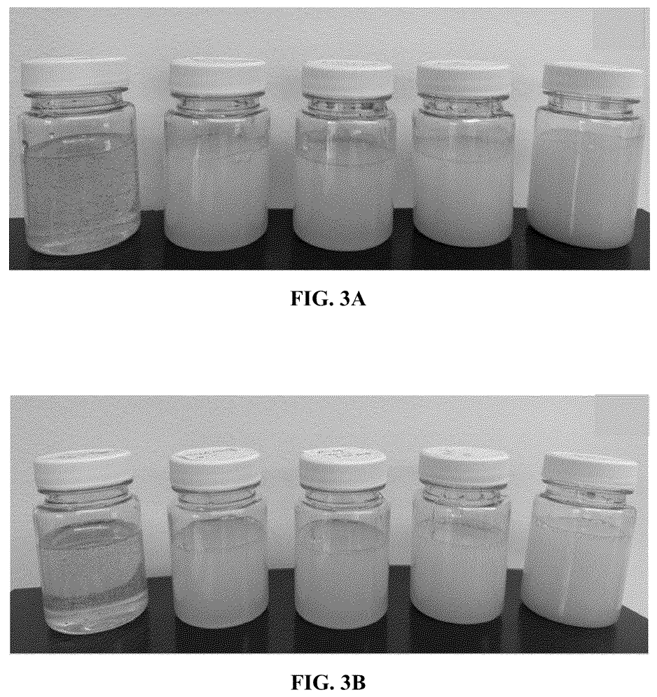

In FIGS. 3A-3B, the concentration of mastic gum in the prepared samples ranges from 0, 0.50%, 1.00%, 1.96%, to 3.85% (going from left to right) by weight. FIG. 3A was taken after the samples were prepared and before accelerated crystallization treatment, and FIG. 3B was taken of the samples after eight weeks of storage at 4° C. As shown in FIG. 3A, the allulose-mastic gum components prepared according to embodiments of the present invention are opaque semi-solids with a white color and high gloss. The opacity and viscosity of the components increase with the increasing concentration of mastic gum. These compositions have a freshening note balancing the sweetness sensation of allulose without bitterness. As apparent from Table 2 and FIG. 3B, no crystallization in the samples was observed when the Experimental sweetener samples (S-I to S-IV) were stored at 4° C. for up to 8 weeks. The result indicates that the presence of mastic gum does not compromise the crystallization stability of allulose.

### Examples SA-I to SA-IV: Allulose-Mastic Gum-Acacia Gum Sweetener Components

Experimental sweetener component samples SA-I to SA-IV, as shown in Table 3, were prepared by a method that includes: (a) melting crystalline allulose to form a melted allulose and avoid caramelization; (b) cooling the melted allulose to about 45° C.-70° C.; and (c) adding mastic gum to the cooled melted allulose to form a homogeneous co-melt mixture, as shown in FIG. 1B. The process also includes (d) preparing a water-based gel by mixing allulose, acacia gum, and water together; (e) cooling the allulose-mastic gum-acacia gum sweetener component to about 40° C. to 55° C.; (f) combining the water-based gel with the homogeneous co-melt mixture to form the allulose-based sweetener with the water-based gel; and then (g) cooling the sweetener to room temperature. Crystallization stability of these samples was measured and are shown below in Table 3.

TABLE 3

| Allulose-mastic | | | | | | | | | Viscosity |
|---|---|---|---|---|---|---|---|---|---|
| gum-water | | Sub- | | Crystallization level at different time | | | | | at 25 +/− |
| sweetening | Main batch | batch | | points when stored at 4° C. | | | | | 0.02 oC |
| components | Ingredient | Ingredient | Content | 3 days | 1 week | 2 weeks | 4 weeks | 8 weeks | (cP) |
| Comparative | Allulose | — | 93.50% | 0 | 2 | 6 | 8 | 10 | 1,883k |
| sweetening | Mastic gum | — | 0.50% | | | | | | |
| sample SA | Water | — | 5.00% | | | | | | |
| Experimental | Allulose | — | 95.54% | 0 | 0 | 0 | 0 | 0 | 14,110k |
| sweetening | (part 1) | | | | | | | | |
| sample SA-I | Mastic gum | — | 0.48% | | | | | | |
| | Hydrogel | acacia gum | 0.42% | | | | | | |
| | | allulose | 0.53% | | | | | | |
| | | (part 2) | | | | | | | |
| | | water | 0.53% | | | | | | |
| Experimental | Allulose | — | 91.84% | 0 | 0 | 0 | 0 | 0 | 6,689k |
| sweetening | (part 1) | | | | | | | | |
| sample SA-II | Mastic gum | — | 0.46% | | | | | | |
| | Hydrogel | acacia gum | 2.20% | | | | | | |
| | | allulose | 2.75% | | | | | | |
| | | (part 2) | | | | | | | |
| | | water | 2.75% | | | | | | |
| Experimental | Allulose | — | 85.27% | 0 | 0 | 0 | 0 | 0 | 1,673k |
| sweetening | (part 1) | | | | | | | | |
| sample SA-III | Mastic gum | — | 0.43% | | | | | | |
| | Hydrogel | acacia gum | 4.08% | | | | | | |
| | | allulose | 5.11% | | | | | | |
| | | (part 2) | | | | | | | |
| | | water | 5.11% | | | | | | |
| Experimental | Allulose | — | 76.63% | 0 | 0 | 0 | 0 | 0 | 568k |
| sweetening | (part 1) | | | | | | | | |
| sample SA-IV | Mastic gum | — | 0.50% | | | | | | |
| | Hydrogel | acacia gum | 6.37% | | | | | | |
| | | allulose | 8.40% | | | | | | |
| | | (part 2) | | | | | | | |
| | | water | 8.20% | | | | | | |

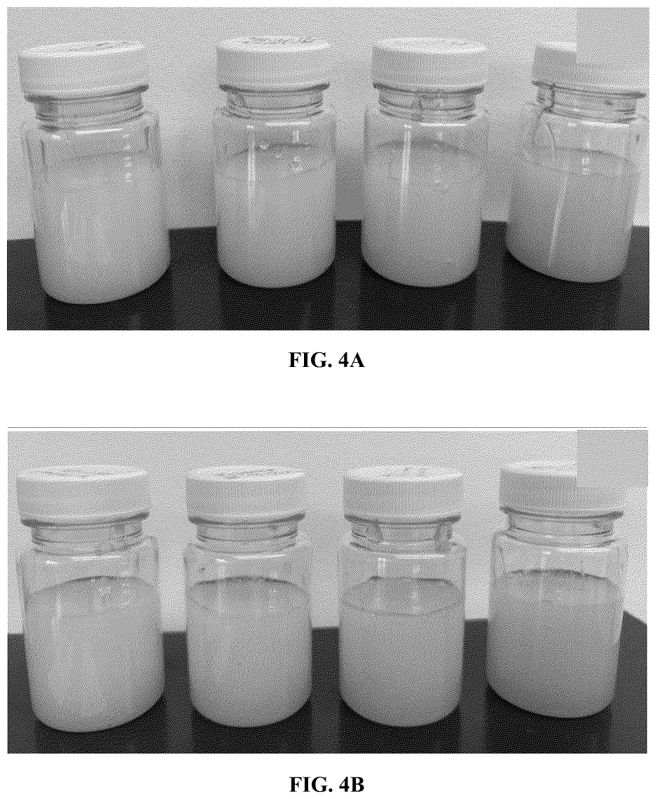

FIG. 4A was taken after samples SA-I to SA-IV were prepared and before accelerated crystallization treatment and FIG. 4B was taken of the samples after eight weeks of storage at 4° C. As shown in FIGS. 4A-4B, the allulose-mastic gum-water compositions having acacia gum are colloid-like liquids. Going from left to right in FIGS. 4A-4B, the allulose concentration is about 96.07%, 94.59%, 90.38%, and 85.03%, the mastic gum concentration ranges from about 0.40% to 0.50%, the acacia gum concentration is about 0.42% 2.20%, 4.08%, and 6.37%, and the water concentration is about 0.53% 2.75%, 5.11%, 8.20%.

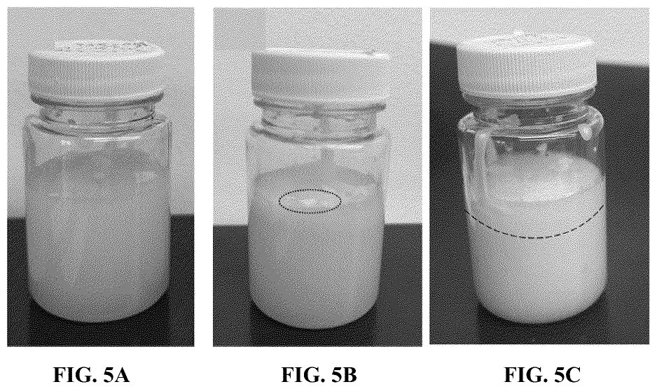

FIGS. 5A-5C show the phase separation and crystallization of Comparative Example SA. FIG. 5A shows Example SA before treatment, FIG. 5B shows Example SA stored at 4° C. for 3 days, and FIG. 5C shows Example SA stored at 4° C. for 2 weeks. In FIG. 5B, the dotted circle marks an area where the occurrence of crystallization is evident. In FIG. 5C, the dotted curve shows the occurrence of phase separation, where the area above the curve has a lower density than the area underneath.

Surprisingly, the modification with the hydrogel, which introduced water to the allulose-mastic gum sweetener composition, where mastic gum is hydrophobic, did not deteriorate the crystallization stability of the composition, where no crystallization of allulose was observed after storage at 4° C. for 8 weeks, as shown in FIG. 4B. In contrast, as shown in FIGS. 5A-5C, storage at 4° C. caused significant crystallization for Comparative Sample SA, which contains 6% water and was prepared in the absence of acacia gum. This result indicates that acacia gum effectively stabilizes water and improves the water compatibility of the allulose-mastic gum compositions.

The viscosity of samples SA and SA-I to SA-IV was also measured under conditions of 0.25 rpm and 25° C. by using a Brookfield DV-II+Pro Viscometer. As shown in Table 3, the viscosity decreases when the content of hydrogel containing water and acacia gum increases.

### FOOD COMPOSITION EXAMPLES

### Examples 1-5

Food compositions made by using allulose-mastic gum sweetener components were prepared and the properties of food compositions made according to embodiments of the present invention were tested. Table 4 below shows the components of the food compositions in Examples 1-5 made according to embodiments of the present invention and the properties after testing.

TABLE 4

| Metal/ | Component | Examples | | | | |
|---|---|---|---|---|---|---|
| Property | Mass% | 1 | 2 | 3 | 4 | 5 |
| Sweetening | Allulose | 69.76 | 69.76 | 69.76 | 69.24 | 68.31 |
| component | Mastic gum | — | 0.37 | 0.73 | 1.46 | 2.19 |
| Nutritive | Cocoa paste | 21.52 | 21.52 | 21.52 | 21.56 | 21.51 |
| bulk agent | Cocoa powder | 5.53 | 5.89 | 5.53 | 5.54 | 5.54 |
| Alkalizing | Calcium | 0.15 | 0.15 | 0.15 | 0.15 | 0.15 |
| agent | from algae | | | | | |
| Natural flavoring agent | | 1.31 | 1.31 | 1.31 | 1.05 | 1.31 |
| Emulsifying | Sunflower | 1.00 | 1.00 | 1.00 | 1.00 | 1.00 |
| agent | Lecithin | | | | | |
| Added | Acacia gum | 0.73 | — | — | — | — |
| texturing | | | | | | |
| agent | | | | | | |

| | | | | | |
|---|---|---|---|---|---|
| Total | 100 | 100 | 100 | 100 | 100.01 |
| Sensory Evaluation | Acceptable | Acceptable | Acceptable | Woody taste | Strong woody taste |
| Lingering (seconds) | 180 ± 4 | 412 ± 5 | 460 ± 8 | 612 ± 8 | 790 ± 8 |
| Firmness (N/cm²) | 147.72 ± 3.71 | 192.07 ± 3.32 | 195.68 ± 4.32 | 221.92 ± 3.73 | 243.10 ± 6.11 |

| | | |
|---|---|---|
| Texture changes causes | Disintegrated | No disintegration |
| by firmness testing | | |
| Water adsorption activity | High | Low |
| Stability under high humidity | Low: Fat blooming | High: No fat blooming |

The food composition in Example 1 includes 0.73% acacia gum and no mastic gum. The food compositions in Examples 2 to 5 are made according to embodiments of the present invention that resist textural changes, have improved chewiness, and give longer lingering in the mouth. These food compositions include about 60% to about 70% allulose as sweetener and about 0.37% to about 2.19% mastic gum as an active ingredient. The amount of mastic gum added in these compositions was adjusted to investigate the effects of mastic gum on the properties of the food compositions. As shown in Table 4, the presence of mastic gum significantly increases the lingering time from about 180±4 seconds for Example 1 to about 412 f 5 seconds for Example 2 and to about 790±8 seconds for Example 5 and enhances the firmness from about 147.72±3.71 N/cm² for Example 1 to about 192.07±3.32 N/cm² for Example 2 and to about 243.10±6.11 N/cm² for Example 5.

The moisture adsorption activity was investigated by measuring the difference in weight before and after the storage experiment. Plastic containers, cups and vials were incubator dried at 40° C. for at least 1 hour and cooled down in a closed contained for at least 3 hours before the storage experiment. Samples of 5.0 grams±0.1 grams were weighed and set upside down with the flat surface facing upward in the central area of a 3.25 oz cup. Each composition was tested with three samples. Each sample was placed in a closed container (32 oz). Before closing the containers, an uncapped 50 mL vial with a 20.0000 g 0.0005 g of deionized water and a portable hygrometer and thermometer were put into each cup. The cups were put into an incubator with temperature set at 25.0° C.±0.2° C. Filling the vial with 20.0000 g of distilled water kept the relative moisture in each closed cup stay at 85±2% at 25° C. After the 24-hour storage experiment, the cups with samples were weighed and photographed. The moisture adsorption is expressed as a percentage of weight gain.

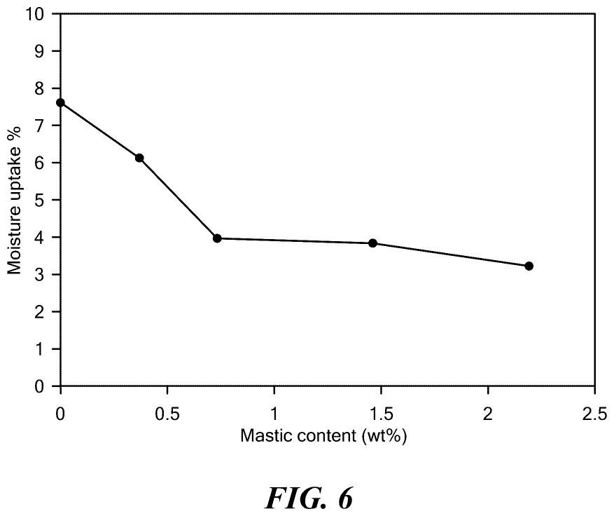

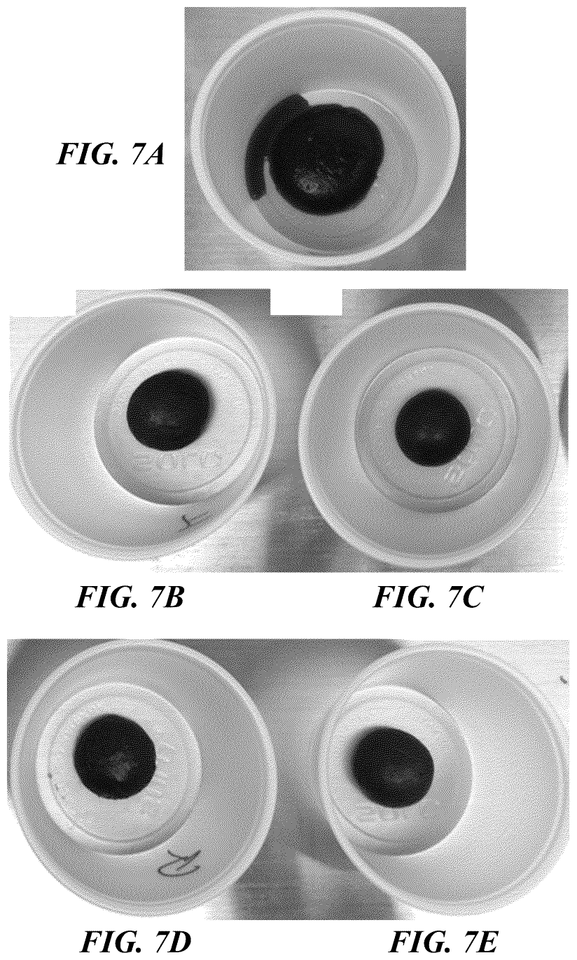

FIG. 6 is a graph of the moisture uptake obtained after 24 hours at 25° C. and relative humidity of 85+/−2% for Examples 1-5. FIGS. 7A-7E are photographs of food compositions made according to Examples 1-5, respectively, after the moisture uptake testing. After 24 hours, there was a noticeable difference among the compositions in the five Examples. Food compositions with mastic gum showed an unexpected reduction in moisture adsorption. As shown in FIG. 6, the food composition in Example 1, which contained acacia gum and no mastic gum, had a weight increase of 7.60±0.24% via moisture sorption. The moisture uptake decreased rapidly from Example 1 with no mastic content with an increase in the mastic content in Examples 2 and 3 and then slowly decreased further as the mastic content increased. The composition of Example 3 had only half of the moisture uptake of the composition of Example 1. The composition of Example 5 had the lowest moisture gain. As shown in FIG. 7A, Example 1, which was made without mastic gum, exhibited significant flow with almost half of the bottom of the cup covered after 24 hours. In contrast, as shown in FIGS. 7B-7E, food compositions made according to Examples 2-5 containing mastic gum resisted moisture sorption and did not exhibit flow under the same testing conditions as Example 1.

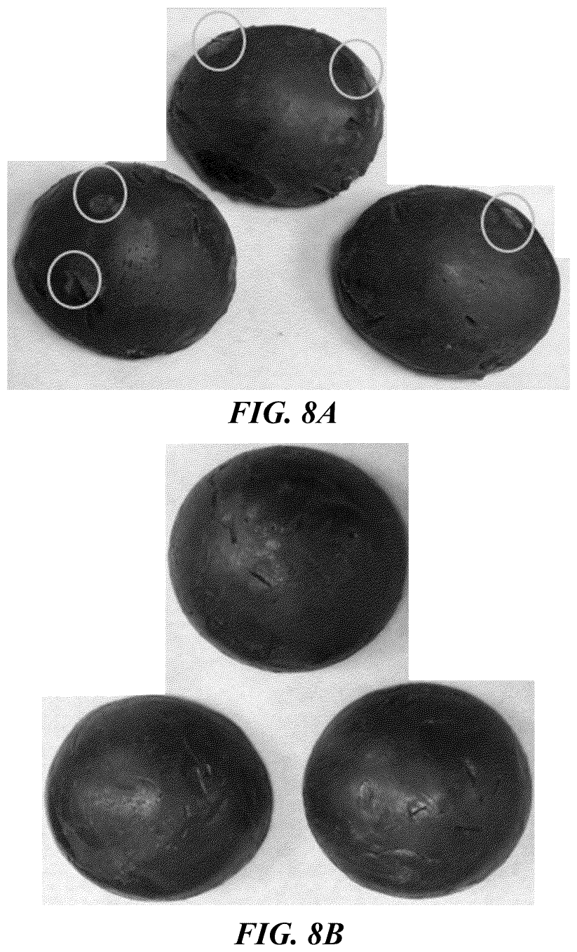

Storage stability of the food compositions was also tested by tracking changes in texture, color, and sensory profile at different time points. The food composition in Example 1 was chewy and had a good consistency in texture when freshly made, but over time (1 month or less when made and packaged with a humidity level of 40% or above; 1 year or more when made and packaged with a humidity level of 25% or less) became soft on the surface and lost the original chewiness, though the central part was still chewy. This indicates the food composition in Example 1 was prone to phase separation. In some cases, where 0.3% water was present, phase separation was even more significant. Food compositions in Examples 2-5 remained more consistent in texture, color, and sensory perception, and resisted the formation of a soft layer on the surface over time as compared to the food composition in Example 1. FIGS. 8A-8B show samples of the food compositions made according to embodiments of the present invention. FIG. 8A shows samples of food compositions made according to Example 1 and FIG. 8B shows samples of food compositions made according to Example 3. Both sets of samples were made, packaged with a humidity of 40%, and stored at room temperature for over two months. As shown in FIG. 8A, fat bloom occurred for the food composition in Example 1. The areas marked with yellow circles in FIG. 8A show that fat migrated through the matrix to the surface of the food composition. Fat bloom was not observed for the food compositions in Examples 2-5. For example, the samples in FIG. 8B, which were made according to the food composition in Example 3, were free from blooming and did not show any fat that migrated to the surface of the composition. This demonstrated that the incorporation of mastic gum helped resist textural changes and fat blooming.

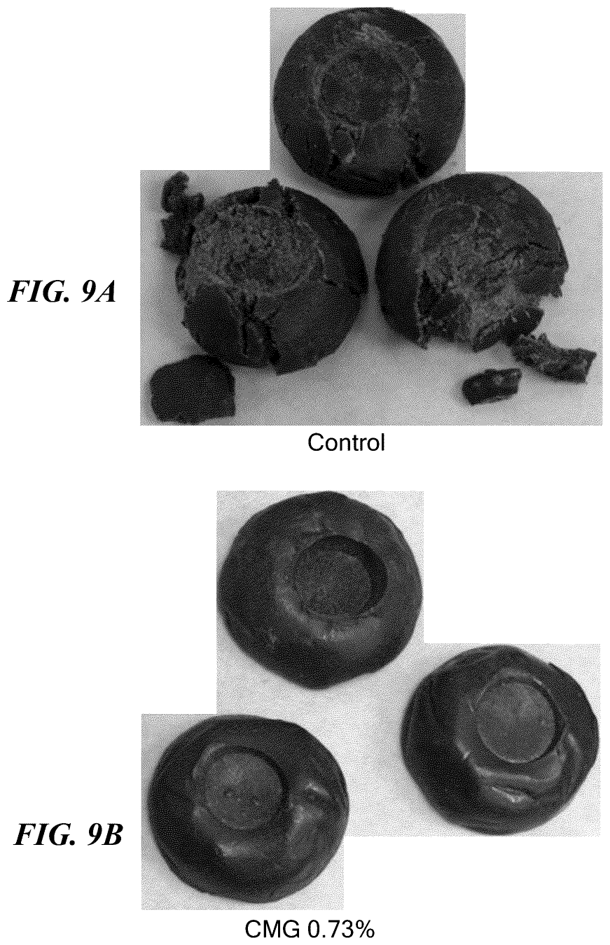

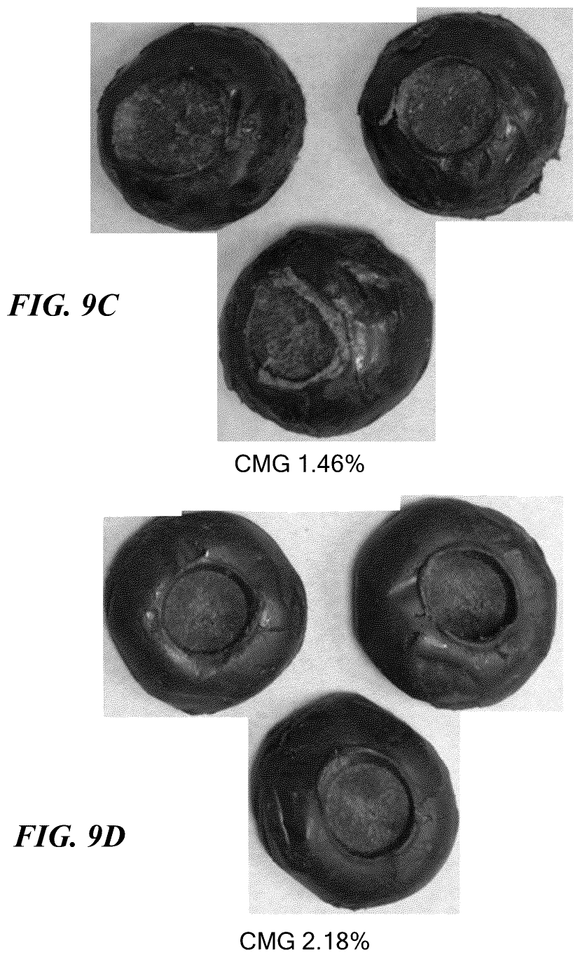

In addition, textural changes were observed for the food compositions made according to Examples 1-5. FIGS. 9A-9D show a comparison of samples stored at room temperature for two months after mixing was done and after firmness testing was performed. FIG. 9A shows the food composition made according to Example 1, FIG. 9B shows the food composition made according to Example 3, FIG. 9C shows the food composition made according to Example 4, and FIG. 9D shows the food composition made according to Example 5. Textural disintegration did not occur for the food compositions in Examples 3 to 5, where mastic resin was present, but there was major textural disintegration for the food composition made according to Example 1, where no mastic resin was present, as shown in FIGS. 9A-9D.

To test sensory evaluation, lingering time, texture changes, and water adsorption, samples of the food compositions were made according to Examples 1-5. The vertical cross section of each sample was semi-elliptical in shape with a cross section of about 2.45 cm and a height of about 1.00 cm. Each sample had a flat surface on the bottom.

The sensory testing indicated that the food compositions in Examples 2-5 had a long-lasting flavor, compared to the food composition in Example 1. However, the taste of the food compositions with mastic gum in an amount higher than 1.0% was undesirable due to a strong woody taste.

The food compositions in Examples 2-5 were much chewier than the food composition in Example 1, but they did not stick to the teeth. Lingering time testing was done by orally tasting the food compositions in Examples 1-5. The lingering time of the compositions was measured by (A) recording the time when 5.0±0.1 g of the material was put in the mouth, (B) lightly chewing the material, and (C) recording the time when the material was no longer present in the mouth. (C) minus (A) is the lingering time. Examples 2-5 demonstrated the beneficial effects on lingering time when substituting mastic gum for acacia gum. The lingering time of the food compositions with mastic gum in Example 2-5 was significantly improved over the lingering time of the food compositions without mastic gum in Example 1 (e.g., 180 seconds±4 seconds). For example, the lingering time increases from about 412 seconds±5 seconds for Example 2 to about 460 seconds±8 seconds for Example 3, about 612 seconds 8 seconds for Example 4, and about 790 seconds±8 seconds for Example 5 while the ratio of mastic gum to allulose increased from about 1:188 for Example 2 to about 1:32 for Example 5. Since the change in lingering time rose with increasing amounts of mastic gum added, the lingering time might therefore be directly related to the presence of mastic gum and the interaction between the mastic gum and the other ingredients existing in the food compositions. Hence, the modification of allulose-sweetened compositions with mastic gum added at a higher ratio of mastic gum to allulose may yield a property characterized with a further increased lingering time, close or similar to that of chewing gum.

The firmness of the food compositions was measured using a VTSYIQI Penecometer with a load of 500 N and a pressure head with a diameter of 1.11 cm. Mastic gum appeared to have a reinforcing effect on the food compositions sweetened with allulose, since the food compositions with mastic gum yielded higher firmness. Examples 2-5 illustrate the effect of substituting the acacia gum with the mastic gum. A correlation was found between increased firmness of the food compositions and an increased ratio of mastic gum to allulose. The food composition in Example 1 having 0.73% acacia gum and no mastic gum only had a firmness of 147.72±3.71 N/cm². In Examples 2 to 5, an increase of the ratio of mastic gum to allulose from about 1:188 to 1:32 resulted in a significant increase in the firmness of the food compositions. For example, the composition in Example 3 had a firmness of about 195.68±4.32 N/cm² in the presence of 0.73% mastic gum. In an additional example, 2.19% mastic gum resulted in an increase in the firmness of the food compositions to about 243.10±6.11 N/cm². These results are consistent with the testing results of lingering time.

### Examples 6-12

Similar to Examples 1-5, food compositions in Examples 6-12 were prepared using allulose-mastic gum sweetener components. Different from Examples 1-5, food compositions in Examples 6-12 had an expanded range of sweetener concentrations, a lower amount of cocoa product, and plant-based proteins, such as nuts, which are rich in unsaturated fats, fiber, vitamins, minerals, and antioxidants. For example, almond flour and/or pumpkin seed protein was used to partially (Examples 6, 7, and 11) or fully (Examples 8, 9, and 12) replace the cocoa product. In Examples 8-12, isomaltulose was used as a secondary sweetener to increase the firmness. In Examples 10 and 11, the concentration of allulose was increased over 80% by weight (Example 10) or even 90% by weight (Example 11) to make samples that taste similar to almond or chocolate bars but have a highly chewy texture. Table 5 below shows the components of the food compositions in Examples 6-12 made according to embodiments of the present invention and the properties after testing.

TABLE 5

| Material/ | Component | Examples | | | | | | |
|---|---|---|---|---|---|---|---|---|
| Property | Mass % | 6 | 7 | 8 | 9 | 10 | 11 | 12 |
| Sweetening | Alluose | 72.73 | 52.42 | 78.17 | 75.53 | 81.55 | 90.22 | 46.72 |
| component | Isomaltulose | — | — | 3.52 | 3.51 | 0.59 | 2.34 | 36.58 |
| | Mastic gum | 0.71 | 0.80 | 2.34 | 5.00 | 0.60 | 1.18 | 0.89 |
| Nutritive | Cocoa paste | — | — | — | — | 12.32 | — | — |
| bulk agent | Cocoa butter | 0.14 | 0.16 | — | — | — | — | — |
| | Cocoa powder | — | — | — | — | 3.29 | 0.59 | — |
| | Almond flour | 26.33 | 16.49 | 14.85 | 12.58 | — | 4.72 | 15.63 |
| | Pumpkin | — | — | — | 2.73 | — | — | — |
| | seed flour | | | | | | | |
| Alkalizing | Calcium | 0.01 | 0.05 | 0.08 | 0.07 | 0.08 | 0.08 | 0.08 |
| agent | from algae | | | | | | | |
| Natural favoring agent | | — | — | 0.92 | 0.50 | 1.37 | 0.81 | — |
| Emulsifying | Sunflower | — | — | — | — | 0.20 | — | — |
| agent | Lecithin | | | | | | | |
| | Mono- and | 0.08 | 0.08 | 0.08 | 0.08 | — | 0.06 | 0.10 |
| | diglycerides | | | | | | | |
| Total | | 100.00 | 100.00 | 100.00 | 100.00 | 100.00 | 100.00 | 100.00 |
| Lingering (seconds) | | 205 ± 7 | 354 ± 13 | 463 ± 6.66 | 635 ± 9.54 | 502 ± 7 | 540 ± 13 | 569 ± 15 |
| Firmness (N/cm²) | | 107.93 ± 9.20 | 185.9 ± 8.18 | 110.5 ± 4.85 | 180.57 ± 7.15 | 220.14 ± 3.78 | 251.53 ± 2.28 | 341.27 ± 0.02 |
| Sensory | Flavor | Acceptable | Acceptable | Acceptable | Acceptable | Acceptable | Acceptable | Acceptable |
| acceptability | Chewiness | Acceptable | Acceptable | Pronounced | Pronounced | Acceptable | Pronounced | Acceptable |
| Texture | Hardening | Absence | Absence | Absence | Absence | Absence | Absence | Absence |
| stability | Grainess | Absence | Absence | Absence | Absence | Absence | Absence | Absence |
| | Stickiness | Absence | Absence | Absence | Absence | Absence | Absence | Absence |

The almond flour allowed the amount of mastic gum to be increased in the food composition, which increased the lingering time without causing an unacceptable taste, and allowed a much higher amount of mastic gum compared to the Examples when a cocoa product was used as the only nutritive bulk agent. As shown in Example 9, a confectionery food composition with a desired lingering time and an acceptable flavor was made by using 5.00% by weight of mastic gum, 12.58% by weight of almond flour, and 2.73% by weight of pumpkin seed protein. As shown in Example 12, the use of isomaltulose as a secondary sweetener also caused an increase in firmness.

Examples 6-12 shown in Table 5 (and the Examples shown in Tables 6-8 discussed below) were tested for sensory acceptability, firmness, chewability, smoothness, stickiness, graininess, and temperature-accelerated hardening. The firmness test was conducted 5 days after the samples were prepared and the testing method was the same as that described above for Examples 1-5. The sensory testing results were conducted using a 5-point scale graded in the following way: absence, slight, acceptable, pronounced, and very pronounced. The hardening test was conducted by putting samples (wrapped in the wrappers) from all the trials in a laboratory oven at 50° C. for 5 days. At the end of the hardening test, samples were taken out of the oven and inspected after they were cooled down to the room temperature. The evaluation results are shown in Tables 5-8. As shown in Table 5-8, none of samples made according to embodiments of the present invention hardened, except a comparative sample having 5 wt % of glycerol as plasticizer (not shown), instead of the water-based gel, which significantly hardened. The comparative sample result suggests another disadvantage of using glycerol plasticizer for low glycemic confectionery formulations.

As confirmed by sensory evaluation, the confectionery food composition samples made according to embodiments of the present invention have acceptable flavor and chewiness. After wrapped in cellophane wrappers and stored at room temperature for over 24 months, Examples 6-12 were still chewy without the occurrence of either graininess, hardening, or softening, and were comparable to Examples 1-5 in storage stability.

### Examples A-1 to A-4, B, and C

Different from Examples 1-12, which were made using allulose-mastic gum sweetener components, the chewy confectionery food compositions in Examples A-1 to A-4, B, and C, which had a soft texture and a higher content of cocoa products, such as 20%-50% by weight cocoa products, were made using the sweetener components having allulose, mastic gum, and a gelling agent according to embodiments of the present invention. Table 6 below shows the formulations that were used to make Examples A-1 to A-4, B, and C.

TABLE 6

| Material/ | Component | Examples | | | | | |
|---|---|---|---|---|---|---|---|
| Property | Mass % | A-1 | A-2 | A-3 | A-4 | B | C |
| Sweetening | Alluose | 67.85 | 63.03 | 60.22 | 42.94 | 67.85 | 67.85 |
| component | (part 1) | | | | | | |
| | Isomaltulose | 3.24 | — | — | | 3.24 | 3.24 |
| | Mastic gum | 0.35 | 2.71 | 0.36 | 1.1 | 0.35 | 0.35 |
| Nutritive | Cocoa paste | 13.7 | 12.41 | 19.93 | 27.89 | 13.7 | 13.7 |
| bulk agent | Cocoa powder | 5.41 | 17.85 | 15.13 | 21.91 | 8.41 | 8.41 |
| | Almond flour | — | 0 | — | | — | — |
| Alkalizing | Calcium | 0.1 | 0.27 | 0.1 | 0.1 | 0.1 | 0.1 |
| agent | from algae | | | | | | |
| Emulsifying | Sunflower | 0.7 | 0.33 | 0.56 | 0.7 | 0.7 | 0.7 |
| agent | Lecithin | | | | | | |
| | Mono- and | 0.5 | 0.33 | 0.62 | 0.7 | 0.5 | 0.5 |
| | diglycerides | | | | | | |
| Hydrogel | Allulose | 1.04 | 0.4 | 0.49 | 0.77 | 1.04 | 1.04 |
| | (part 2) | | | | | | |
| | Acacia gum | 0.69 | 0.98 | 1.18 | 1.85 | 0.345 | — |
| | Gellan gum | — | — | — | | 0.345 | — |
| | Guar gum | — | — | — | | — | 0.345 |
| | Xanthum gum | — | — | — | | — | 0.345 |
| | Monk fruit | | 0 | 0.04 | 0.06 | | |
| | extract | | | | | | |
| | Brown rice | 0.14 | — | 0.05 | 0.08 | 0.14 | 0.14 |
| | protein | | | | | | |
| | Water | 1.04 | 0.43 | 0.52 | 0.51 | 1.04 | 1.04 |
| Natural flavoring agent | | 2.24 | 1.26 | 0.8 | 1.09 | 2.24 | 2.24 |
| Total | | 100 | 100 | 100 | 100 | 100 | 100 |
| Sensory | Flavor | Acceptable | Acceptable | Acceptable | Acceptable | Acceptable | Acceptable |
| Evaluation | Chewiness | Acceptable | Acceptable | Acceptable | Less chewy | Acceptable | Acceptable |
| | Smoothness | Smoothy | Smoothy | Smoothy | Smoothy | Smoothy | Less smoothy |
| Firmness (N/m²) | | 167.76 ± 4.58 | 149.37 ± 9.19 | 210.23 ± 17.47 | 197.67 ± 15.67 | 157.27 ± 3.97 | 243.97 ± 5.76 |
| Texture | Stickiness | Absence | Absence | Absence | Absence | Slight | Absence |
| stability | Hardening | Absence | Absence | Absence | Absence | Absence | Absence |
| | Graininess | Absence | Absence | Absence | Absence | Absence | Absence |

Example A-1 was made for testing oral health effects after a satisfactory sensory evaluation involving nearly 20 tasters. Examples A-3 and A-4 included monk fruit extract in the acacia gun-based gel. The use of monk fruit as a high intensity sweetener allowed the amount of allulose to be reduced while increasing the amount of nutritive bulk agents, such as cocoa products (35% for Example A-3 and 50% for Example A-4), which enhances the nutritional value of the food composition.

Example B was a chewy, soft confectionery food composition with about 20% cocoa products, mastic gum, and a water-based gel including acacia gum, gellan gum, and brown rice protein. Example C was a chewy, soft confectionery food composition with about 20% cocoa products, mastic gum, and a water-based gel including guar gum, xanthan gum, and brown rice protein.

Examples A-1 to A-4, B, and C were made by preparing three sub-batches according to embodiments of the present invention. In the preparation of sub-batch I, a co-melt of sweeteners was prepared by melting a mixture of allulose and isomaltulose to form the co-melt, which was then cooled. When the co-melt temperature was in the range of about 55° C. to about 65° C., mastic gum was added to the co-melt, melted, and dispersed in the co-melt to form a uniform mixture that flowed. In the preparation of sub-batch II, a gel solution was made by stirring and dissolving brown rice protein and acacia gum in distilled water at room temperature. Allulose was added to the gel solution and mixed to get a viscous gel solution. The viscous, water-based gel solution formed in sub-batch II was combined with the mixture formed in sub-batch I and further mixed together in a mixer at about 60° C. to form a blended mixture or an homogeneous, base compound. The blended mixture was removed from the mixer and cooled. In the preparation of sub-batch III, natural plant-based ingredients were mixed together. Once the temperature of the blended mixture reached room temperature, the blended natural plant-based ingredients obtained in sub-batch III was combined with the blended mixture from sub-batches I and II to form the food composition.

### Examples D, E-1 to E-4, F, G

Examples D, E-1 to E-4, F, and G included allulose-mastic gum sweetener components with gelling agents and plant-based ingredients, selected from almond flour, pumpkin seed protein, barley protein, and coffee cherry powder, to fully or partially replace the cocoa products to make soft, chewy snack food compositions. Examples D, E-1 to E-4, F, and G were made according to embodiments of the present invention, by preparing three sub-batches similar to Examples A-1 to A-4, B, and C, except as noted below. Table 7 shows the formulations that were used to make Examples D, E-1 to E-4, F, and G.

TABLE 7

| Material/ | Component | Examples | | | | | | |
|---|---|---|---|---|---|---|---|---|
| Property | Mass % | D | E-1 | E-2 | E-3 | E-4 | F | G |
| Sweetening | Allulose | 67.85 | 67.85 | 67.33 | 69.09 | 62.52 | 67.85 | 55.06 |
| | (part 1) | | | | | | | |
| component | Isomaltulose | 3.24 | 3.24 | — | — | — | 3.24 | — |
| | Trehalose | — | — | 3.21 | — | — | — | — |
| | Mastic gum | 0.35 | 0.35 | 0.35 | 0.35 | 0.68 | 0.35 | 3.42 |
| Nutritive | Cocoa paste | — | — | 0.6 | 5.31 | — | 13.7 | 10.7 |
| bulk agent | Cocoa butter | 8.39 | — | — | — | — | — | — |
| | Cocoa powder | — | 8.39 | 3.36 | 2.11 | — | 8.03 | 3.88 |
| | Almond flour | — | 13.72 | 19.47 | 17.49 | 32.5 | — | 0 |
| | Pumpkin | 13.72 | — | — | — | — | — | — |
| | seed flour | | | | | | | |
| | Barley protein | | — | — | — | — | — | 20.29 |
| | Coffee cherry | — | — | — | — | — | 2.35 | — |
| | powder | | | | | | | |
| Alkalizing | Calcium | 0.1 | 0.1 | 0.1 | 0.1 | 0.01 | 0.1 | 0.09 |
| agent | from algae | | | | | | | |
| Emulsifying | Sunflower | 0.7 | 0.7 | 0.49 | 0.48 | 0.33 | — | 0.43 |
| agent | Lecithin | | | | | | | |
| | Mono- and | 0.5 | 0.5 | 0.68 | 0.61 | 0.51 | — | 0.43 |
| | diglycerides | | | | | | | |
| Hydrogel | Allulose | 1.04 | 1.04 | 0.82 | 0.8 | 0.85 | 1.04 | 0.76 |
| | (part 2) | | | | | | | |
| | Acacia gum | 0.69 | 0.35 | 2.03 | 1.97 | 1.81 | — | 0.89 |
| | Gellan gum | — | 0.35 | — | — | — | — | — |
| | Guar gum | — | — | — | — | — | 0.35 | — |
| | Xanthum gum | — | — | — | — | — | 0.35 | — |
| | Monk fruit | — | — | 0.06 | 0.06 | — | — | — |
| | extract | | | | | | | |
| | Brown rice | 0.14 | 0.14 | — | — | — | 0.14 | 0.74 |
| | protein | | | | | | | |
| | Water | — | — | 0.85 | 0.83 | 0.79 | 1.04 | 1.42 |
| | Green tea | 1.04 | — | — | — | — | — | — |
| | extract | | | | | | | |
| | Coffee extract | — | 1.04 | — | — | — | — | — |
| Natural flavoring agent | | 2.24 | 2.23 | 0.65 | 0.8 | — | 1.46 | 1.89 |
| Total | | 100 | 100 | 100 | 100 | 100 | 100 | 100 |
| Sensory | Flavor | Acceptable | Acceptable | Acceptable | Acceptable | Acceptable | Acceptable | Acceptable |
| Evaluation | Chewiness | Acceptable | Acceptable | Acceptable | Acceptable | Acceptable | Acceptable | Acceptable |
| | Smoothiness | Smoothy | Smoothy | Smoothy | Smoothy | Smoothy | Smoothy | Smoothy |
| Firmness (N/cm²) | | 159.40 ± 5.32 | 172.87 ± 3.45 | 125 04 ± 9.95 | 165.55 ± 5.91 | 88.92 ± 6.62 | 68.94 ± 2.03 | 193.94 ± 7.96 |
| Texture | Stickiness | Absence | Absence | Absence | Absence | Absence | Absence | Absence |
| stability | Hardening | Absence | Absence | Absence | Absence | Absence | Absence | Absence |
| | Graininess | Absence | Slight | Absence | Absence | Absence | Slight | Grainy |

As shown in Table 7, the chewy, confectionery food composition in Example D included mastic gum and an acacia gum-based gel including green tea extract and brown rice protein. Different from Example A-i, which had 13.7% cocoa paste and 8.41% cocoa powder, Example D had 13.72% pumpkin seed protein and 8.39% cocoa butter instead. In addition, tea extract, instead of water, was used as the solvent when making the gel solution for Example D. The batch of tea extract was made by adding 2 g of green tea leaves to 180 ml of boiled water and brewing the green tea leaves for 4 minutes, filtering the tea water through a coffee filter, and letting the tea water cool to room temperature. Natural compounds contained in green tea, such as polyphenols and catechins have antibacterial properties, helping plaque and cavity prevention by inhibiting the growth of cariogenic bacteria.

Examples E-1 to E-4 are chewy, confectionery food compositions enriched with almond flour. Examples E-1 to E-4 were prepared using almond flour to partially (Examples E-1 to E-3) or fully (Example E-4) replace the cocoa product. Example E-1 contains 13.72% almond protein as the replacement for cocoa paste, which was used in an amount of 13.7% in Example A-1. In addition, vitamin-rich ingredients, including 0.43% acerola extract, which contains vitamins A and C, and 0.37% papaya extract, which contains vitamins A, C, and E, and B complex vitamins, were included in the natural flavoring agent for Example E-1. Coffee extract, instead of water, was used as the solvent when making the gel solution for Example E-1. The batch of coffee extract water was made by adding 2 g of ground coffee bean powder to 180 ml of boiled water and brewing for 4 minutes, filtering the coffee water through a coffee filter, and letting the coffee extract cool to room temperature. Coffee extract contains chlorogenic acid and polyphenols that have significant antibacterial effects. These compounds can help inhibit the growth of harmful oral bacteria, especially Streptococcus mutans, which is the primary cause of cavities and plaque formation.

Example F is a chewy, confectionery food composition including a coffee cherry powder made according to embodiments of the present invention. Coffee cherry is an agricultural waste product during coffee processing, has only 0.53% caffeine, is rich in antioxidants, has more potassium than banana, and has more iron than spinach. Example F includes 2.35% coffee cherry powder as the replacement for a blend of caffeine-free natural ingredients, such as in Example A-1. Example G had a chewy, soft texture, which can be used as a soft filling for a chewy, confectionery food composition according to embodiments of the present invention. The soft filling described in Example G could be used with any of the chewy food compositions made according to embodiments of the present invention, such as described in Examples 1-12, A-1 to A-4, B-D, E-1 to E-4, and F, which can be used as the shell for the filling, to provide low glycemic, vegan confectionery food compositions with a core-shell structure.

### Comparative Examples A-C

The following three comparative compositions were prepared for investigating the effects of different compositions. These comparative compositions were prepared by using the same method described in Example A-1. The formulations for these comparative compositions are shown below in Table 8.

TABLE 8

| Material/ | Component | Comparative Examples | | |
|---|---|---|---|---|
| Property | Mass % | A | B | C |
| Sweetening | Allulose (part 1) | 67.85 | 67.85 | 67.85 |
| component | Isomaltulose | 3.24 | 3.24 | 3.24 |
| | Mastic gum | — | 0.35 | — |
| Nutritive bulk | Cocoa paste | 13.7 | 13.7 | 13.7 |
| agent | Cocoa powdeer | 8.41 | 8.06 | 9.59 |
| Alakalizing agent | Calcium from algae | 0.1 | 0.1 | 0.1 |
| Emulsifying agent | Sunflower lecithin | 0.7 | 0.7 | 0.7 |
| | Mon- and | 0.5 | 0.5 | 0.5 |
| | diglycerides | | | |
| Hydrogel | Allulose (part 2) | 1.04 | 1.04 | 1.04 |
| | Acacia gum | 1.04 | — | — |
| | Brown rice | 0.14 | 1.18 | — |
| | protein | | | |
| | Water | 1.04 | 1.04 | 1.04 |
| Natural flavoring agent | | 2.24 | 2.24 | 2.24 |
| Total | | 100 | 100 | 100 |
| Sensory | Flavor | Acceptable | Acceptable | Acceptable |
| Evaluation | Chewiness | Less | Poor | Poor |
| | | Acceptable | | |
| | Smoothness | Smoothy | Smoothy & | Poor |
| | | | Foamy | |
| Firmness (N/cm²) | | 105.43 ± 3.21 | 155.47 ± 4.26 | 166.70 ± 5.32 |
| Texture stability | Stickiness | Slight | Poor | Poor |
| | Hardening | Absence | Absence | Slight |
| | Graininess | Absence | Absence | Poor |

Compared to Example A-1, Comparative Example A does not include mastic gum. Comparative Example A was used as a comparison for Example A-1 when testing for oral health effects. Compared to Example A-1, Comparative Example B does not include acacia gum. Comparative Example C, wherein both brown rice protein and hydrocolloids were absent, was made to ascertain whether water was compatible with the mass of sweetener co-melt and mastic gum when water was added to the composition without first being immobilized by the gel solution. Comparative Example C was found to cause severe graininess and blooming of fat, which was believed to be due to the phase separation caused by incorporating 1.04% water, which was not immobilized by the gel solution.

Overall, the confectionery food compositions shown in Tables 4-7, which were made according to embodiments of the present invention had improved stability compared to Comparative Examples A-C, shown in Table 8.

As shown with the texture and sensory evaluation results in Tables 4-7, embodiments of the present invention enable allulose to be used as the main bulking sweetener, and optionally with a secondary sweetener as a minor bulking sweetener, to make low glycemic and vegan friendly confectionery food compositions, which were not sticky to teeth, dental restorations, and platelet, and prevented surface softening or phase separation during storage.

According to the firmness testing, a combination of mastic gum at about 0.35% by weight and an acacia gum-based gel at about 2.9 wt % (Example A-1 in Table 6) provide a confectionery food composition having acceptable chewiness and firmness (167.76±4.58 N/cm²), comparable to that of a commercially available fruit chew product that contains gelatin (165.56±3.58 N/cm²). The Comparative Example A had 37% less firmness than Example A-1, consistent with the sensory evaluation result that indicated Comparative Example A had less chewiness. One preferred food composition includes 0.35% mastic gum by weight, 0.69% acacia gum by weight, and with or without 0.14% brown rice protein by weight. When half of the acacia gum was replaced with gellan gum and all other conditions were kept constant (Example B in Table 6), the chewy confectionery food composition had a lower firmness (157.27±3.97 N/cm²) compared to Example A-1, was slightly sticky to the teeth, and had acceptable sensory properties, as shown in Table 6. Example C was prepared by using a 1:1 blend of guar gum and xanthan gum as a replacement for acacia gum. As shown in Table 6, the firmness of the chewy confectionery food composition in Example C was much higher (243.97±5.76 N/cm²) compared to Examples A-1 and B, most likely due to the guar gum and xanthan gum providing a highly viscous gel. This firmness in Example C was close to that of other commercially available chewy candy containing gelatin (245.23±4.97 N/cm²). Because the gel solution made with guar gum and xanthan gum had a viscosity significantly higher than the gels made using either acacia gum or the blend of acacia gum and gellan gum, the confectionery food composition in Example C had a greater resistance when chewed. As a result, Example C can be chewed for a longer time, compared to Examples A-1 and B.

The sensory tests show that including multiple natural plant-based ingredients did not affect the taste of compositions made using the gels, which were delicious. Example D had a unique flavor combination due to the presence of pumpkin seed protein, which had a neutral flavor with a slight hint of nut, in combination with green tea powder and mastic gum. Example D had a light green color, making it different from all the other confectionery food compositions made according to embodiments of the present invention, which had a deep brown color. Example D may be of interest to consumers who like green tea. Examples E-1 to E-3, made using cocoa powder and almond protein, also had a unique flavor combination. The almond protein had a slightly sweet and nutty taste, which complemented the bold flavor of coffee (in Example E-1), the rich flavor of cocoa powder, and the unique flavor of mastic gum.

### Evaluation of Oral Care Food Composition Consumption on the Regrowth and Metabolic Activity of Dental Plaque

The food compositions prepared according to Example A-1 and Comparative Example A were used to evaluate the effects on subsequent growth and acid production of human dental bacteria after consuming the food compositions. 19 healthy adults aged 18-65 years old of different races and genders were included in the evaluation. Participants were asked to refrain from oral hygiene practices the night before and the morning of the test visit and were restricted from eating and drinking (except water) from 10 p.m. the evening before the day of testing. On the day of testing, a cotton swab (CONSTIX SC-9, CONTEC, Spartanburg, SC, USA) was used to collect overnight supragingival dental plaque samples from the buccal and lingual surfaces along the gingival margin in the maxillary and mandibular left quadrants of the subject. These pre-exposure plaque samples were designated as “Pre-” samples. Participants then consumed one piece of the test food compositions, which was held in the mouth for 5 minutes to allow contact with the dental plaque on tooth surfaces. Twenty minutes after consuming the test sample, supragingival plaque samples from the maxillary and mandibular right quadrants were collected (designated as ‘Post-’ samples). No eating or drinking was permitted during the plaque sampling and collection period. All plaque samples were placed in glass tubes on ice until further laboratory processing.

All plaque samples, both before (Pre-) and after (Post-) exposure, were analyzed in vitro using a modified PGRM method (White et al., 1995). All Pre- and Post-plaque samples were resuspended in 0.03% Tryptic Soy Broth (TSB, BD, Becton, Dickinson and Company, Sparks, MD, USA), vortexed for 30 seconds and adjusted to OD600 nm=0.20 in sterilized glass tube (16×100 mm). The normalized plaque samples were kept on ice prior to testing.

Statistical analysis was conducted using SPSS software (LBM Corp., Armonk, NY, USA). ANOVA and paired t-tests were employed to determine significant differences among the test candies, with significance set at a p-value of <0.05. Differences among the groups were further explored using Tukey's multiple comparison.

For regrowth assay, 300 μl of normalized plaque was mixed with 650 μl of 5% TSB and 50 μl of 40% sucrose. Regrowth (OD600 nm) was measured (Spectronic 20 Genesys, Spectronic instruments, UK) at 0, 2 and 4 h after incubation at 37° C. 0.03% TSB without the plaque samples was used as control for both tests.

As shown in Table 9, the average regrowth of pre-consumption plaque samples increased from OD600 nm 0.031 to 0.055 at 2 hours and to 0.237 at 4 hours for the Example A-1 group. Post-consumption plaque samples grew from an average of 0.029 to 0.044 at 2 hours, and to 0.167 at 4 hours. The difference in regrowth between pre- and post-consumption was significant (p<0.05).

For the Comparative Example A group, the average regrowth of pre-consumption plaque samples increased from OD600 nm 0.031 to 0.057 at 2 hours, and to 0.273 at 4 hours. Post-consumption plaque samples grew from an average OD of 0.030 to 0.049 at 2 hours, and to 0.236 at 4 hours (Table 9). The difference in regrowth between pre- and post-consumption samples was less significant (p<0.05).

When the regrowth after exposure to the test samples was compared among the two groups, the experimental food composition group (Example A-i) showed a much lower regrowth with mean OD (0.167) at 4 hours after consumption, compared to Control candy group (0.236) (Table 9). This result shows that food compositions made according to embodiments of the present invention had an inhibitory effect on bacterial regrowth after brief exposure to human dental plaque.

TABLE 9

| Regrowth of before | | | | |
|---|---|---|---|---|
| and after intervention | | Optical density (OD600 nm) | | |
| Time (hours) | | 0 | 2 | 4 |
| Example | pre- | 0.031 ± 0.006 | 0.055 ± 0.015 | 0.237 ± 0.124 |
| A-1 | consumption | | | |
| | post- | 0.029 ± 0.005 | 0.044 ± 0.013 | 0.167 ± 0.091 |
| | consumption | | | |
| Comparative | pre- | 0.031 ± 0.004 | 0.057 ± 0.018 | 0.273 ± 0.181 |
| Example A | consumption | | | |
| | post- | 0.03 ± 0.004 | 0.049 ± 0.016 | 0.236 ± 0.194 |
| | consumption | | | |

For acid production, 950 d of normalized plaque sample was mixed with 50 μl of 40% sucrose, incubated at 37° C. in a Thermomixer (Thermo Scientific, FisherScientific) at 1,200 rpm. Acid production (pH) was measured at 0, 2 and 4 h using a micro-pH electrode (InLab Micro Combination pH Electrode, METTLER TOLEDO), which was calibrated prior to each use. Changes in acid production (ΔpH) were defined as the pH difference between Post- and Pre-exposure, calculated using the following formulas:

$$Δ pH = Δ pHPost - Δ pHPre$$

$$Δ pHPost 2 or 4 h = pHPost 2 or 4 h - pHPost 0 h$$

$$Δ pHPre 2 or 4 h = pHPre 2 or 4 h - pHPost 0 h$$

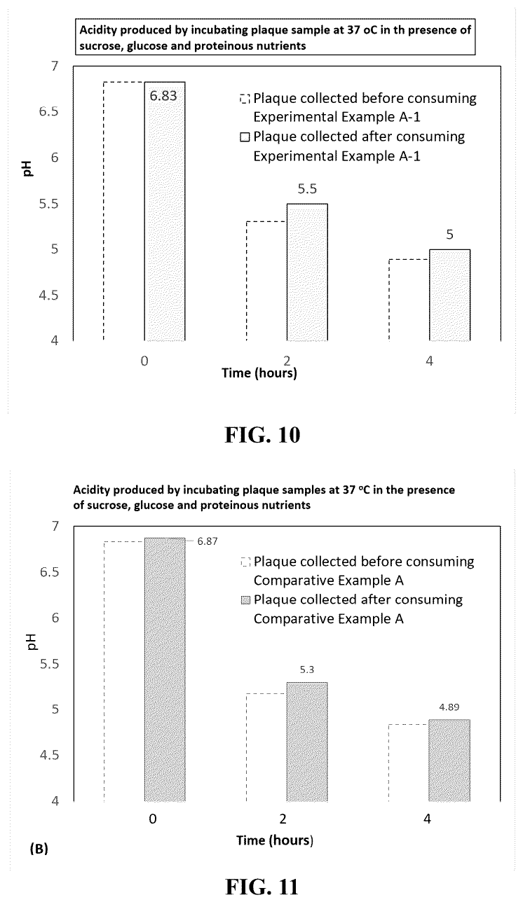

As shown in FIG. 10, the average pH of post-consumption samples decreased from 6.83 to nearly 5.50 at 2 hours and to 5.00 at 4 hours. The difference in acid production between pre- and post-consumption of oral care food composition Example A-1 was statistically significant (p<0.05). This result shows that food compositions made according to embodiments of the present invention containing allulose and mastic gum provide a healthier food composition, compared to the acidogenic candies that promote acid production and the risk of dental caries, by reducing the acid production after exposure.

As shown in FIG. 11, the average pH of pre-consumption plaque samples in the Comparative Example A group decreased from 6.83 to 5.18 at 2 hours and 4.84 to 4 hours due to acid production. The average pH of post-consumption samples decreased from 6.87 to 5.30 at 2 hours and to 4.89 at 4 hours, as shown in FIG. 11. The difference in acid production between pre- and post-consumption samples shows that Comparative Example A was also useful in reducing the production of acids by dental plaque bacteria. However, the effect was not as significant as Example A-1.

### Evaluation of the Effects of Food Compositions on Oral Microbiota

In parallel, an in vivo test was conducted to investigate the effects of two samples (Example A-1 vs Comparative Example A) on the composition and functions of the oral microbiota. These two samples tested were selected in terms of consistency. Different from the plaque regrowth and glycolysis method used above, a method of sequencing of the 16S rRNA gene was employed to profile microbial communities of plaque and saliva following consumption of the samples.

The test lasted for 5 days. During the test, participants were exposed to three conditions: (I) normal diet, (II) Comparative composition (Comparative Example A) intervention, or (III) Experimental composition (Example A-1) intervention. Normal diet included 3 meals to be maintained every day through the test. Intervention II included chewing one Comparative composition sample (5.0±0.1 g) following each of 3 meals for 2 minutes on Day 3. Intervention III included chewing the Experimental composition sample (5.0±0.1 g) following each of 3 meals for 2 minutes on Day 5. Plaque and saliva samples were collected using OMR-610 and OMR-110 collection kits (DNA Genotek), respectively. Samples for Intervention I were collected on day 1. Samples for Intervention II were collected on day 3. Samples for Intervention III were collected on Day 5. For each of the 3 intervention conditions, AM samples were collected in the morning before oral care and PM samples were collected in the evening following the exposure period. For each of these intervention conditions, the morning samples collected for each intervention condition are compared to the evening samples. Shogun metagenomic sequencing was performed using an Illumina NextSeq 2000 platform at a 2M bp read depth to provide sufficient taxonomic resolution.

As evident in Table 10, there was a significant decrease (AM vs PM) in plaque biomass found following the consumption of Experimental Composition, which resulted in a significant reduction of plaque biomass (−80%), compared to the diet control and Comparative composition. The participants noted a “sensation” of reduced surface plaque, and increased difficulty in collecting plaque following Intervention III.

TABLE 10

| Effects on plaque biomass and | | Comparative | | Experimental | | Diet | |
|---|---|---|---|---|---|---|---|
| bacterial composition | | Composition A | | Composition A-1 | | Control | |
| Plaque Biomass | | 225% | | −81.0% | | 16.0% | |
| | Time | AM | PM | AM | PM | AM | PM |
| Genera | Streptococcus | 0.175 +/− 0.025 | 0.24 +/− 0.015 | 0.15 +/− 0 | 0.165 +/− 0.03 | 0.23 +/− 0.11 | 0.37 +/− 0.08 |
| abundance | Veillonella | 0.062 +/− 0.033 | 0.04 +/− 0.015 | 0.078 +/− 0.037 | 0.115 +/− 0.025 | 0.078 +/− 0.03 | 0.042 +/− 0.02 |

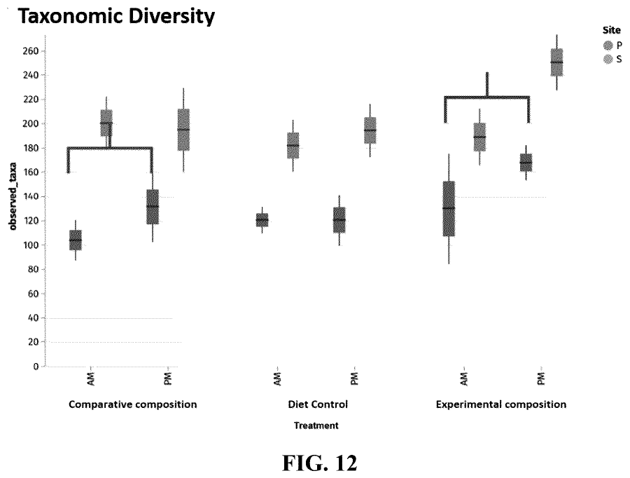

Diversity analysis showed food intervention has a significant impact on oral microbial diversity. As shown in FIG. 12, there was a significant increase in the taxonomic diversity of plaque sample (from 130±15 to 165±10) and saliva sample (from 195±10 to 255 f 10) after consuming the experimental composition (Example A-1), compared to the other two interventions. The results suggests that Example A-1 had a beneficial effect on oral microbiota by promoting microbial diversity.

All the intervention conditions also altered the dental plaque microbiome by affecting the bacterial composition. As shown in Table 10, there was a significant reduction in the abundance of Streptococcus and an increased (AM to PM) enrichment of Veillonella, after consumption of the experimental composition compared to the other two intervention conditions. Veillonella is a genus associated with healthy oral biofilms, metabolizing lactic acid produced by cariogenic bacteria, and converting it to less acidic compounds, which may help protect enamel from demineralization. This result clearly shows the oral health benefits of Example A-1 that can shift the biofilm into a healthier state with enhanced anti-cariogenic potential.

The overall findings shown in the evaluations of dental plaque and oral microbiota indicate that food compositions including allulose and mastic gum have beneficial effects that may help maintain or promote oral health by reducing plaque bacterial growth, reducing plaque acid production, increasing bacterial diversity, and shifting oral bacterial composition to a health-compatible state.

Although the above discussion discloses various exemplary embodiments of the invention, it should be apparent that those skilled in the art may make various modifications that will achieve some of the advantages of the invention without departing from the true scope of the invention.

What is claimed is:

1. A food composition comprising:
allulose having a concentration of about 43% to about 82% by weight;
a cocoa product having a concentration of about 15% to about 50% by weight; and
mastic gum or powder having a concentration of about 0.35% to about 2.71% by weight.

2. The food composition of claim 1, further comprising one or more plant-based proteins having a concentration of about 0.05% to about 0.14% by weight.

3. The food composition of claim 1, further comprising:
at least one secondary sweetener having a concentration of about 0.6% to about 4% by weight, wherein the at least one secondary sweetener is isomaltulose and/or trehalose.

4. The food composition of claim 1, wherein the cocoa product includes cocoa butter, cocoa paste, and/or cocoa powder.

5. The food composition of claim 1, further comprising at least one gelling agent or polysaccharide hydrocolloid having a concentration of about 0.6% to about 1.9% by weight and water having a concentration of about 0.4% to about 1.0%, wherein the at least one polysaccharide hydrocolloid includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan.

6. The food composition of claim 1, further comprising one or more natural ingredients comprising polyphenol having a concentration of about 0.6% to about 2.5% by weight, wherein the one or more natural ingredients include grape seed extract, cranberry powder or extract, elderberry powder or extract, green tea powder or extract, coffee bean powder or extract, coffee cherry powder, hibiscus extract, fennel seed powder or extract, cardamom seed powder or extract, cinnamon powder or extract, beetroot powder, acerola extract, papaya extract, and/or ginger extract.

7. The food composition of claim 1, further comprising one or more biominerals having a concentration of about 0.1% to about 0.2% by weight, wherein the one or more biominerals includes calcium, magnesium, silicon, fluoride, and/or phosphate.

8. A food composition comprising:
allulose having a concentration of about 55% to about 90% by weight;
mastic gum or powder having a concentration of about 0.35% to about 5% by weight; and
one or more plant-based proteins having a concentration of about 4.7% to about 32.5% by weight.

9. The food composition of claim 8, wherein the one or more plant-based proteins include almond protein, pumpkin seed protein, and/or sesame seed protein.

10. The food composition of claim 8, further comprising:
at least one secondary sweetener having a concentration of about 2% to about 4% by weight, wherein the at least one secondary sweetener is isomaltulose and/or trehalose.

11. The food composition of claim 8, further comprising a cocoa product having a concentration of about 0.1% to about 14.6% by weight, wherein the cocoa product includes cocoa butter, cocoa paste, and/or cocoa powder.

12. The food composition of claim 8, further comprising at least one gelling agent or polysaccharide hydrocolloid having a concentration of about 0.7% to about 2.0% by weight and water having a concentration of about 0.4% to about 1.4%, wherein the at least one polysaccharide hydrocolloid includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan.

13. The food composition of claim 8, further comprising one or more natural ingredients comprising polyphenol having a concentration of about 0.6% to about 2.5% by weight, wherein the one or more natural ingredients include grape seed extract, cranberry powder or extract, elderberry powder or extract, green tea powder or extract, coffee bean powder or extract, coffee cherry powder, hibiscus extract, fennel seed powder or extract, cardamom seed powder or extract, cinnamon powder or extract, beetroot powder, acerola extract, papaya extract, and/or ginger extract.

14. The food composition of claim 8, further comprising one or more biominerals having a concentration of about 0.1% to about 0.2% by weight, wherein the one or more biominerals includes calcium, magnesium, silicon, fluoride, and/or phosphate.

15. A method of making a food composition, the method comprising:
melting crystalline allulose to form a melted allulose;
cooling the melted allulose to about 45° C. to about 70° C.;
adding mastic gum or powder to the cooled melted allulose to form a mixture; and
blending one or more plant-based proteins and/or one or more cocoa products with the mixture at a temperature of about 45° C. to about 70° C. to form a blended mixture.

16. The method of claim 15, further comprising melting at least one secondary sweetener with the crystalline allulose, wherein the mastic gum or powder is added to the cooled melted allulose and melted secondary sweetener to form the mixture, wherein the at least one secondary sweetener is isomaltulose and/or trehalose.

17. The method of claim 15, further comprising dissolving at least one polysaccharide hydrocolloid in water to form a gel solution and adding the gel solution to the blended mixture, wherein the at least one polysaccharide hydrocolloid includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan.

18. The method of claim 15, further comprising adding one or more natural ingredients comprising polyphenol to the blended mixture, wherein the one or more natural ingredients include grape seed extract, cranberry powder or extract, elderberry powder or extract, green tea powder or extract, coffee bean powder or extract, coffee cherry powder, hibiscus extract, calcium from algae, fennel seed powder or extract, cardamom seed powder or extract, cinnamon powder or extract, beetroot powder, acerola extract, papaya extract, and/or ginger extract.

19. The method of claim 15, wherein the one or more plant-based proteins include brown rice protein, almond protein, pumpkin seed protein, and/or sesame seed protein.

20. The method of claim 15, further comprising adding one or more biominerals to the blended mixture, wherein the one or more biominerals includes calcium, magnesium, silicon, fluoride, and/or phosphate.

21. A method of making an allulose-based sweetener for use in a food composition, the method comprising:
providing allulose having a concentration of about 75.0% to about 99.5% by weight of the allulose-based sweetener;
melting the allulose to form a melted allulose;
cooling the melted allulose to about 45° C. to about 70° C.; and
adding mastic gum or powder having a concentration of about 0.4% to about 4.0% by weight of the allulose-based sweetener to the cooled melted allulose to form a mixture.

22. The method of claim 21, further comprising melting at least one secondary sweetener with the allulose, wherein the mastic gum or powder is added to the cooled melted allulose and melted secondary sweetener to form the mixture, wherein the at least one secondary sweetener is isomaltulose and/or trehalose.

23. The method of claim 21, further comprising:
dissolving at least one gelling agent or polysaccharide hydrocolloid in water to form a gel solution, the at least one gelling agent or polysaccharide hydrocolloid having a concentration of about 0.4% to about 7.0% by weight and water having a concentration of about 0.5% to about 9.0% by weight of the allulose-based sweetener, wherein the at least one polysaccharide hydrocolloid includes acacia gum or powder, guar gum or powder, locust bean gum or powder, gellan gum or powder, xanthan gum or powder, cellulose gum or powder, plant-derived chitosan, carob seed gum, tamarind seed gum, tara gum, gum tragacanth, agar, agarose, alginates, carrageenan, chia seeds, basil seeds, konjac, pectin, and/or pullulan; and
adding the gel solution to the mixture.
